(19) United States
(12) Patent Application Publication
(10) Pub. No.: US 2012/0272185 A1
(43) Pub. Date: Oct. 25, 2012

(54) SYSTEMS AND METHODS FOR MIXED-MEDIA CONTENT GUIDANCE

(75) Inventors: Chad Dodson, San Ramon, CA (US); James Pozenel, Ann Arbor, MI (US); Donald Scott Brown, Rives Junction, MI (US); Jennifer Stroth, San Jose, CA (US); David Jordan, San Francisco, CA (US); Jeffrey Barr, San Jose, CA (US); Daniel Wright Trenz, Ann Arbor, MI (US)

(73) Assignee: ROVI TECHNOLOGIES CORPORATION, Santa Clara, CA (US)

(21) Appl. No.: 13/340,851

(22) Filed: Dec. 30, 2011

Related U.S. Application Data
(60) Provisional application No. 61/429,803, filed on Jan. 5, 2011.

(51) Int. Cl. G06F 3/048

(52) U.S. Cl. 715/810

(57) ABSTRACT

Systems and methods for mixed-media content guidance are provided. One or more interactive tools are provided for searching and/or filtering media content (e.g., music content, movie content, etc.). In some embodiments, these interactive tools may include a two-dimensional selection region, where the two-dimensional selection region is divided into a plurality of sub-regions and defines an intersection between a first criterion and a second criterion. In response to receiving a user selection of a sub-region from the two-dimensional selection region, a subset of a plurality of media identifiers may be determined. At least a portion of the subset of media identifiers may be selected for presentation to the user.

### CROSS-REFERENCE TO RELATED APPLICATION

This application claims the benefit under 35 U.S.C. §119(e) of U.S. Provisional Patent Application No. 61/429,803, filed Jan. 5, 2011, which is hereby incorporated by reference herein in its entirety.

### BACKGROUND OF THE INVENTION

With society awash in an ever-increasing quantity of media content, and as such media content becomes ever more widely available, advanced media guidance application support is becoming increasingly important. For example, with the overwhelming volume of media content available to the average user, it is often difficult for users to decide what media content to consume. At the same time, a convergence of media types and systems is driving the need for media guidance applications to manage and exploit the relationships between different kinds of media content.

### SUMMARY OF THE INVENTION

In view of the foregoing, systems and methods for managing and providing content in a mixed-media environment using an interactive media guidance application are provided. For example, the media guidance application may be provided as an on-line application (e.g., provided on a website) that presents users with information associated with movies, television, music, compositions, actors, artists, other entertainment-related content, or a combination thereof. In particular, the interactive media guidance application may provide a user with guidance for selecting content of various content types, such as movies, television programs, and music.

In some embodiments, interactive tools may be provided that allow the user to search and/or filter content based on different criteria. Content may be filtered by a category and/or a subcategory (e.g., a genre, a subgenre, or any other suitable category of interest), a rating (e.g., PG-13, PG, R, etc.), a time period (e.g., 1980s, 1990s, etc.), a demographic (e.g., toddlers), a theme (e.g., activity), a mood (e.g., positive, negative, chill, wild, etc.), and/or any other suitable criterion. For example, an interactive tool may be provided that allows users to search and/or filter content based on the user's mood. In response to receiving an indication of mood from the user, the control circuitry may search for a television show, music, or a movie with metadata describing one or more moods (e.g., sober, wild, melancholy, ecstatic, etc.) matching the indicated mood.

One of the interactive tools may include a two-dimensional selection region, where the two-dimensional selection region is divided into a plurality of sub-regions and defines an intersection between a first criterion and a second criterion. For example, the two-dimensional selection region may define the intersection between two different moods. In another example, the two-dimensional selection region may define the intersection between a mood (e.g., having the bounds positive and negative) and a genre (e.g., having the bounds drama and comedy).

It should be noted that, in some embodiments, multiple two-dimensional selection regions may be provided. For example, a first two-dimensional selection region that defines the intersection between two sets of moods (e.g., a vertical axis with a “positive” upper bound and a “negative” lower bound and a horizontal axis with a “wild” upper bound and a “chill” lower bound) and a second two-dimensional selection region that defines the intersection between two sets of genres (e.g., a vertical axis with a “light” upper bound and a “heavy” lower bound and a horizontal axis with a “romance” upper bound and a “comedy” lower28857355_{—}1 bound). In response to selecting a sub-region from each two-dimensional selection region, control circuitry may determine one or more media identifiers and their corresponding content for presentation to the user for selection, retrieval, and/or playback.

In some embodiments, the media guidance application may allow the user to select one or more criterion for placement in the two-dimensional selection region. For example, the control circuitry may transmit a query to a database or any other suitable source to determine criterion available for placement in the two-dimensional selection region. In response to receiving the available criterion, the control circuitry may populate a prompt that is provided to the user for selecting one or more criterion. In response to selecting criteria, the control circuitry may provide a two-dimensional selection region that is divided into a plurality of sub-regions and that defines an intersection between the selected criteria.

In some embodiments, the media guidance application may use metadata associated with media content to assist the user in making a selection. For example, the interactive media guidance application may include techniques for managing and exploiting the relationships between different kinds of media content, such as between movies, television, and music. In a more particular example, metadata associated with the media content may be cross-referenced and linked in order to provide users with relevant information spanning the array of media content types.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with some embodiments of the invention;

FIG. 3 shows an illustrative user equipment device in accordance with some embodiments of the invention;

FIG. 4 shows a simplified diagram of an interactive media system in accordance with some embodiments of the invention;

FIG. 5 is a diagram of an illustrative cross-platform interactive media system in accordance with some embodiments of the invention;

FIGS. 6 and 7 show illustrative display screens of a media guidance application that may be used to provide guidance for various types of media in accordance with some embodiments of the invention;

FIGS. 8-13 show illustrative display screens of a media guidance application that may be used to provide criteria for search and/or filtering media content (e.g., music content) in accordance with some embodiments of the invention;

FIG. 14 shows illustrative portions of display screen that may be used to provide a preview audio clip in response to selecting a particular portion of a media identifier in accordance with some embodiments of the invention;

FIGS. 15 and 16 show an illustrative display screen of a media guidance application that may be used to access information and other media content associated with a particular album, song, or other audio content in accordance with some embodiments of the invention;

FIG. 17 shows an illustrative display screen of a media guidance application with an overlay containing information related to a currently queued or playing song in accordance with some embodiments of the invention;

FIG. 18 shows an illustrative display screen of a media guidance application that may be used to provide information and other media content associated with a particular song in accordance with some embodiments of the invention;

FIGS. 19-21 show an illustrative display screen of a media guidance application that may be used to search and/or filter music or other audio content using a two-dimensional selection region (for two sets of moods) in accordance with some embodiments of the invention;

FIGS. 22-27 show illustrative display screens of a media guidance application that may be used to provide criteria for search and/or filtering media content (e.g., movie content and/or video content) in accordance with some embodiments of the invention;

FIGS. 28 and 29 show an illustrative display screen of a media guidance application that may be used to access information and other media content associated with a particular movie or other video content in accordance with some embodiments of the invention;

FIG. 30 shows an illustrative display screen of a media guidance application with an overlay containing a trailer or video clip related to a particular movie or other video content in accordance with some embodiments of the invention;

FIGS. 31-34 show an illustrative display screen of a media guidance application that may be used to access information and/or a media clips related to media content associated with a particular movie (or other video content) in accordance with some embodiments of the invention;

FIG. 35 shows an illustrative display screen of a media guidance application that may be used to access additional information (e.g., synopsis and cast information) associated with a particular movie or other media content in accordance with some embodiments of the invention;

FIGS. 36-39 show an illustrative display screen of a media guidance application that may be used to access information and/or media content associated with a person (e.g., an actor, an artist, or a performer) including a filmography snapshot portion in accordance with some embodiments of the invention;

FIGS. 40-43 show illustrative display screens of a media guidance application that includes a persistent media queue and allows a user to access music and/or video clips, or other information, related to media content displayed in a cycling advertorial in accordance with some embodiments of the invention;

FIGS. 44-47 show illustrative display screens of a media guidance application include a persistent media queue that manages one or more lists of music content and/or video content in accordance with some embodiments of the invention;

FIG. 48 shows an illustrative display screen of a media guidance application depicting a recommendation feature in accordance with some embodiments of the invention;

FIG. 49 illustrates a flow diagram for selecting media content in response to receiving user-selected criteria from at least a two-dimensional selection region in accordance with some embodiments of the invention; and

FIG. 50 shows an illustrative example of a file in Extensible Markup Language (XML) for retrieving media identifiers used to generate selection displays in accordance with some embodiments of the invention.

### DETAILED DESCRIPTION OF EMBODIMENTS

This invention generally relates to systems and methods for managing and providing content in a mixed-media environment using an interactive media guidance application. In particular, systems and methods are provided for searching and/or filtering content of various content types, such as movies, television programs, and music, with a two-dimensional selection region, where the two-dimensional selection region is divided into a plurality of sub-regions and defines an intersection between a first criterion and a second criterion.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

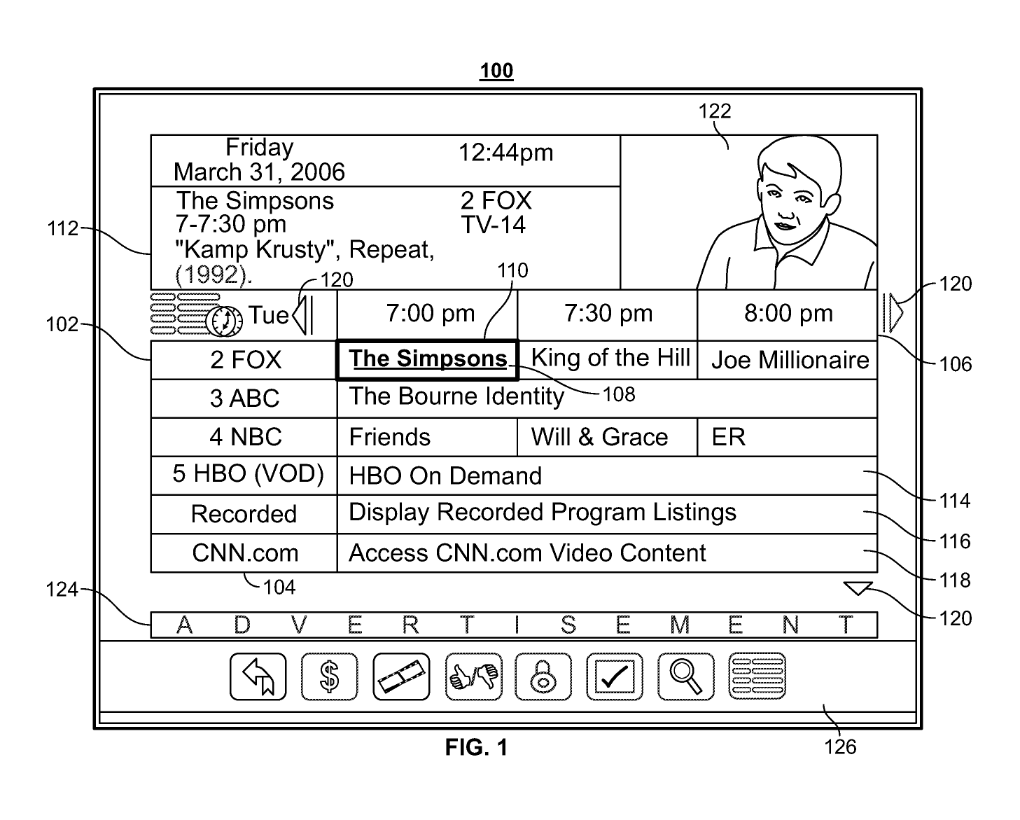

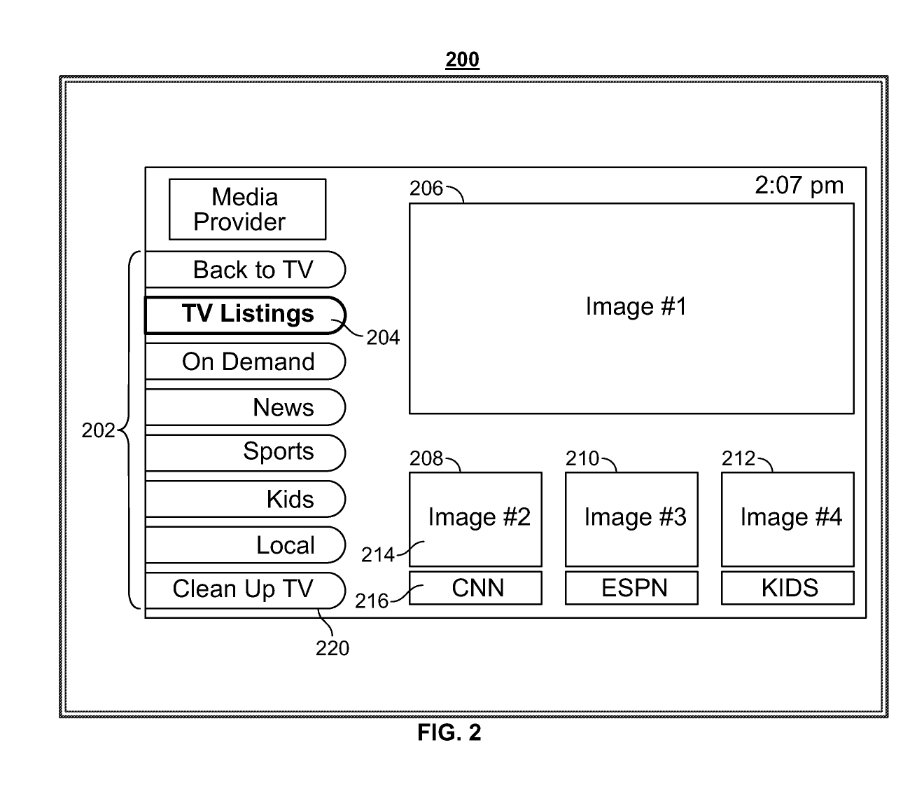

FIGS. 1-2 show illustrative display screens that may be used to provide media guidance data. The display screens shown in FIGS. 1-2 and 6-48 may be implemented on any suitable user equipment device or platform. While the displays of FIGS. 1-2 and 6-48 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

For example, as described above, the media guidance application may select one or more criteria for searching and/or filtering media content based on a user profile, user history, previously recorded content, previously ordered content, parental control settings, etc.

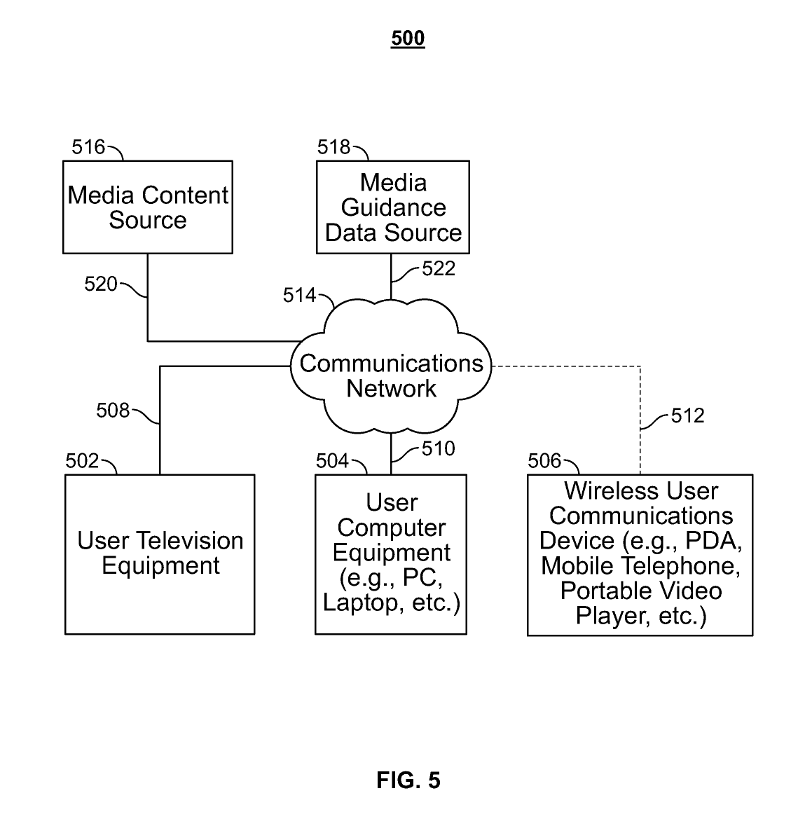

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 5. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200, the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

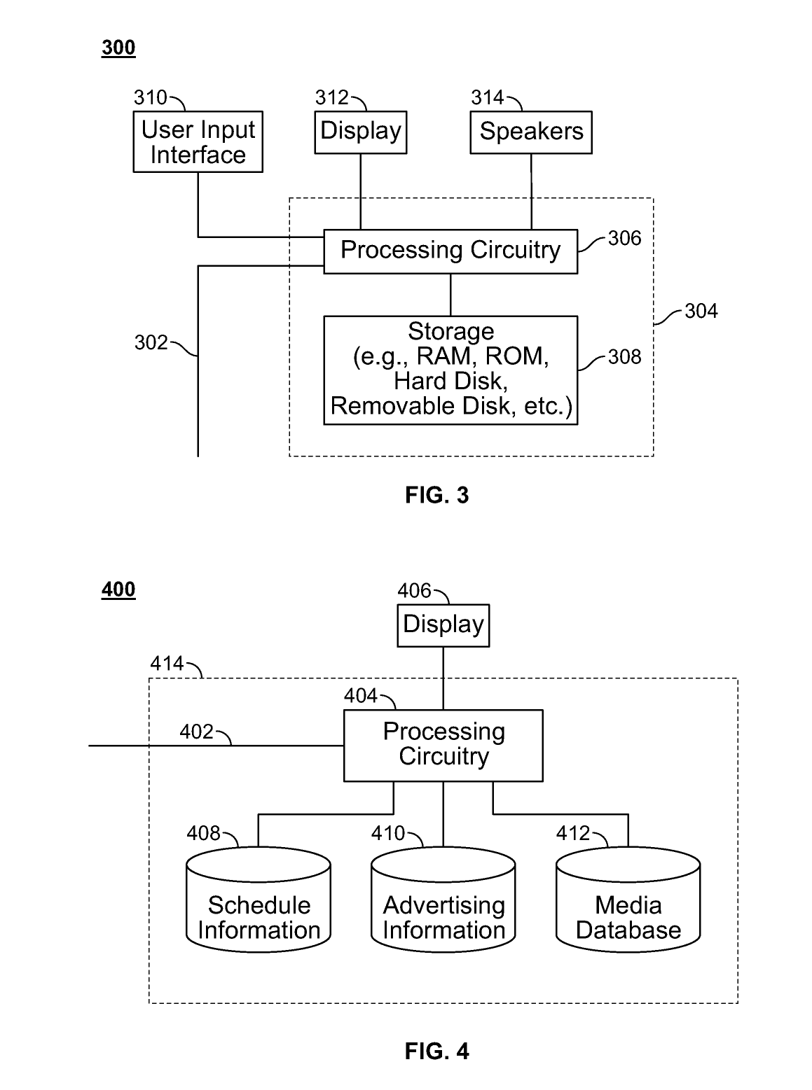

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 5. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 5, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

In some embodiments, control circuitry 304 may be configured to receive instructions from user input interface 310. For example, control circuitry 304 may cause media guidance application listings to be presented by selecting a selectable option in a display screen (e.g., a listings option) or pressing a dedicated button (e.g., a GUIDE button) on a remote control or other user input interface 310.

In some embodiments, control circuitry 304 may be configured to receive one or more user selections of criteria using user input interface 310 to search and/or filter media content. For example, control circuitry 304 may present the user with a two-dimensional selection region that defines an intersection between a first criterion and a second criterion, where the first criterion and the second criterion are associated with a plurality of media identifiers. The two-dimensional selection region may also be divided into a plurality of sub-regions, where the user selection indicates at least one of the sub-regions. In response to receiving the user selection, control circuitry 304 may determine a subset of media identifiers that correspond to the selected sub-region. For example, control circuitry 304 may transmit a query to a database or any other suitable source for media content having metadata that meets the user-selected criteria derived from the selected sub-region. Control circuitry 304 may then present at least a portion of the subset of media identifiers to the user. For each media identifier, control circuitry 304 may provide the user with various options, such as playing a preview of the media content, retrieving and/or downloading the media content, accessing information relating to the media content, accessing supplemental media content related to the media content, recording the media content, setting a reminder for the media content, etc.

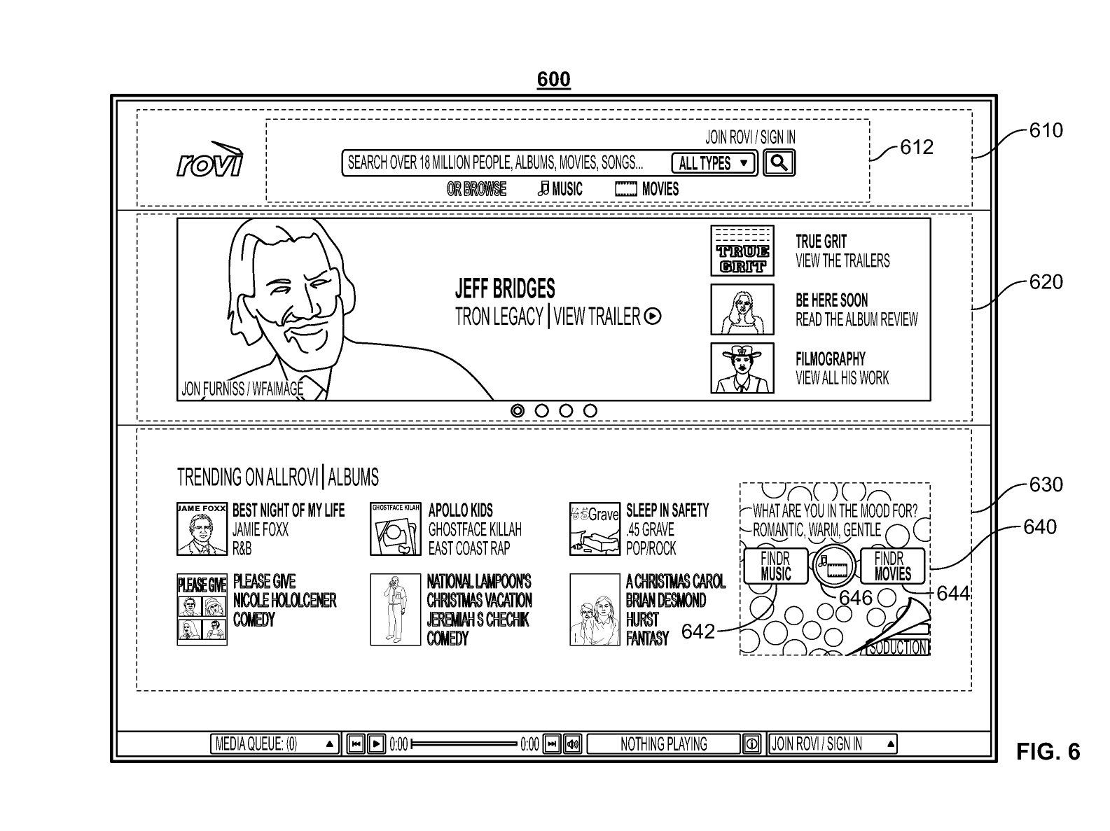

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, in some embodiments in which the media guidance application is implemented as an on-line application, such as a web site or other Internet-based application, the illustrative display screens of FIGS. 6-48 described herein, may be displayed to the user through a web browser implemented using control circuitry 304. As another example, the display screens of FIGS. 6-48 may be displayed on display 312. User indications and interaction with the display screens of FIGS. 6-48 may be received with interface 310 and processed by circuitry 306.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

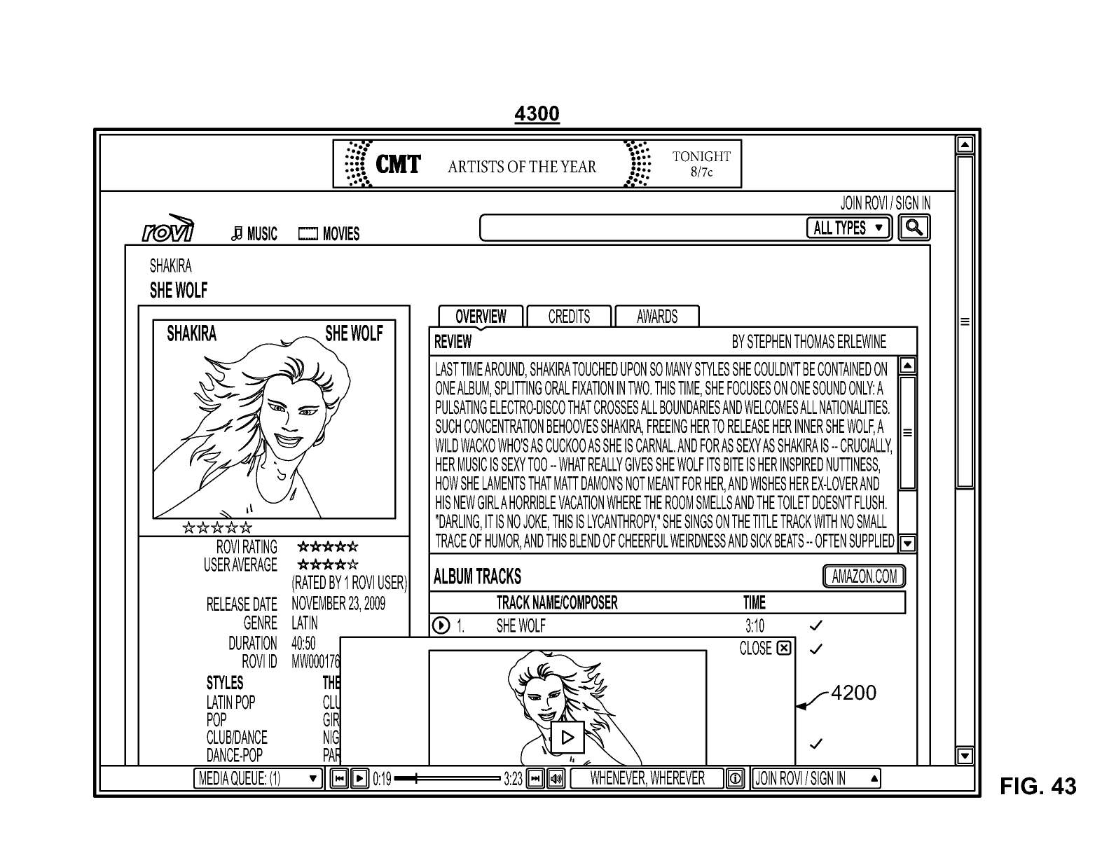

FIG. 4 shows a simplified diagram of an interactive media system in accordance with some embodiments of the invention. User equipment device 400 is a more detailed, yet still simplified, view of user equipment device 300 of FIG. 3. In addition to the features and functionalities described herein in connection with FIGS. 6-48, user equipment device 400 may include any of the components, features, and functionalities described above in connection with FIG. 3. Control circuitry 414 of user equipment device 400 may include processing circuitry 404, schedule information data store 408, advertising data store 410, and media data store 412. Data stores 408, 410, and 412 may each be one or more relational databases or any other suitable storage mechanisms. Although data stores 408, 410, and 412 are shown as separate data stores, one or more of these data stores may instead be combined into a single storage system. Although only data stores 408, 410, and 412 are shown in FIG. 43, it will be understood that there may be any suitable number of data stores.

Schedule information data store 408 may store media guidance data for a media guidance application. Schedule information data store 408 may store media-related information (e.g., broadcast times, broadcast channels, server/storage location, media titles, media descriptions, ratings information (e.g., parental control ratings, critic's ratings, etc.), genre or category information, actor information, logo data for broadcasters' or providers' logos, etc.), media format, on-demand information, or any other suitable information. The schedule information included in schedule information data store 408 may be used by the media guidance application to provide media content information (e.g., as shown in the display screens of FIGS. 6-48) on display 406, or to provide any other suitable media guidance display.

Advertising data store 410 may store advertising content for display in a media guidance application. Advertising data store 410 may store advertising content in various forms, including text, graphics, images, video clips, content of any other suitable type, or references to remotely stored content. Advertising data store 410 may also store links or identifiers to advertising content in other data stores. In some embodiments, advertising data store 410 may store indexes for advertising content in other local data stores (e.g., data store 408 or 412), or may store identifiers to remote storage systems, such as URLs to advertisements provided by web servers. Data store 410 may also store identifying information about each advertisement or advertisement element (e.g., associated advertiser, type of promotional, length of promotion, a television show, product, or service the advertisement is promoting, etc.), or may store indexes to locations in other local or remote storage systems where this information may be found.

Media database 412 may store media content or information related to media content accessible through a media guidance application. For example, the media content and/or media related information displayed in the display screens and overlays of FIGS. 6-48 may be stored and/or downloaded to media database 412. Upon display to the user, media database 412 may be accessed to retrieve the requested information or media content.

Processing circuitry 404, which may have any of the features and functionalities of processing circuitry 306 (FIG. 3), may access any of the information included in data stores 408, 410 and 412. Processing circuitry 404 may use this information to select, prepare, and display information on display 406. In particular, processing circuitry 404 may use information obtained from these data stores to provide a media guidance application with advertisements to a user of user equipment 400. For example, processing circuitry 404 may use this information to display the display screens of FIGS. 6-48. Processing circuitry 404 may also use the information included in data stores 408, 410, and 412 to select, prepare, and output audio to speakers 314 of FIG. 3. In addition, processing circuitry 404 may update information in data stores 408, 410 and 412 with data received from, for example, communications link 402. Communications link 402 may have any of the features and functionalities of communications links 508, 510, and 512 of FIG. 5, discussed in greater detail below. In some embodiments, processing circuitry 404 may update schedule information in data store 408 with new or updated information, may add, remove, or change any advertising content in data store 410, and may add, remove, or change media content or information associated with media content in data store 412 or any other suitable data store. Processing circuitry 404 may additionally update any of the associations between these data stores.

User equipment device 300 of FIG. 3 and user equipment device 400 of FIG. 4 can be implemented in system 500 of FIG. 5 as user television equipment 502, user computer equipment 504, wireless user communications device 506, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 or FIG. 4 may not be classified solely as user television equipment 502, user computer equipment 504, or a wireless user communications device 506. For example, user television equipment 502 may, like some user computer equipment 504, be Internet-enabled allowing for access to Internet content, while user computer equipment 504 may, like some television equipment 502, include a tuner allowing for access to television programming. The media guidance application may have the same layout on various different types of user equipment or may be tailored to the display capabilities of the user equipment. For example, on user computer equipment 504, the guidance application may be provided as a web site accessed by a web browser. In another example, the guidance application may be scaled down for wireless user communications devices 506.

In system 500, there is typically more than one of each type of user equipment device but only one of each is shown in FIG. 5 to avoid overcomplicating the drawing. In addition, each user may utilize more than one type of user equipment device and also more than one of each type of user equipment device.

In some embodiments, a user equipment device (e.g., user television equipment 502, user computer equipment 504, wireless user communications device 506) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 514. Namely, user television equipment 502, user computer equipment 504, and wireless user communications device 506 are coupled to communications network 514 via communications paths 508, 510, and 512, respectively. Communications network 514 may be one or more networks including the Internet, a mobile phone network, mobile voice or data network (e.g., a 4G or LTE network), cable network, public switched telephone network, or other types of communications network or combinations of communications networks. Paths 508, 510, and 512 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless paths, if desired).

Communications with the user equipment devices may be provided by one or more of these communications paths, but are shown as a single path in FIG. 5 to avoid overcomplicating the drawing.

Although communications paths are not drawn between user equipment devices, these devices may communicate directly with each other via communication paths, such as those described above in connection with paths 508, 510, and 512, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 514.

System 500 includes content source 516 and media guidance data source 518 coupled to communications network 514 via communication paths 520 and 522, respectively. Paths 520 and 522 may include any of the communication paths described above in connection with paths 508, 510, and 512. Communications with the content source 516 and media guidance data source 518 may be exchanged over one or more communications paths, but are shown as a single path in FIG. 5 to avoid overcomplicating the drawing. In addition, there may be more than one of each of content source 516 and media guidance data source 518, but only one of each is shown in FIG. 5 to avoid overcomplicating the drawing. (The different types of each of these sources are discussed below.) If desired, content source 516 and media guidance data source 518 may be integrated as one source device. Although communications between sources 516 and 518 with user equipment devices 502, 504, and 506 are shown as through communications network 514, in some embodiments, sources 516 and 518 may communicate directly with user equipment devices 502, 504, and 506 via communication paths (not shown) such as those described above in connection with paths 508, 510, and 512.

Content source 516 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 516 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 518 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 518 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 518 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 518 may provide user equipment devices 502, 504, and 506 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 518) running on control circuitry of the remote server. When executed by control circuitry of the remote server (such as media guidance data source 518), the media guidance application may instruct the control circuitry to generate the guidance application displays and transmit the generated displays to the user equipment devices. The server application may instruct the control circuitry of the media guidance data source 518 to transmit data for storage on the user equipment. The client application may instruct control circuitry of the receiving user equipment to generate the guidance application displays.

Content and/or media guidance data delivered to user equipment devices 502, 504, and 506 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 500 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 5.

In one approach, user equipment devices may communicate with each other within a home network. User equipment devices can communicate with each other directly via short-range point-to-point communication schemes describe above, via indirect paths through a hub or other similar device provided on a home network, or via communications network 514. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 516 to access content. Specifically, within a home, users of user television equipment 502 and user computer equipment 504 may access the media guidance application to navigate among and locate desirable content. Users may also access the media guidance application outside of the home using wireless user communications devices 506 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 514. These cloud resources may include one or more content sources 516 and one or more media guidance data sources 518. In addition or in the alternative, the remote computing sites may include other user equipment devices, such as user television equipment 502, user computer equipment 504, and wireless user communications device 506. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 504 or wireless user communications device 506 having content capture feature. Alternatively, the user can first transfer the content to a user equipment device, such as user computer equipment 504. The user equipment device storing the content uploads the content to the cloud using a data transmission service on communications network 514. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

In some embodiments, control circuitry 304 may receive a request from the user for media guidance for selecting content of various content types, such as movies, television programs, and music. In response to receiving the request, control circuitry 304 may provide the user with a media guidance application (e.g., by accessing a website, initiating an application, etc.). The media guidance application may be provided as an on-line application (e.g., provided on a website) that presents users with information associated with movies, television, music, compositions, actors, artists, other entertainment-related content, or a combination thereof.

FIGS. 6-48 show illustrative display screens that may be used to provide media guidance in accordance with some embodiments of the invention. The display screens shown in FIGS. 6-48 may be implemented on any suitable device or platform. As referred to herein, platform refers to any system that may support the operation of an interactive media guidance application.

It should be noted that, while some of the displays depicted in FIGS. 6-48 are illustrated as full screen displays, they may also be fully or partially overlaid over media content being displayed. For example, while the display screens of FIGS. 6-48 may be implemented as one or more pages of a website, it should also be understood that they may be implemented within an application running on a television, a Smart TV, a set-top box, an integrated receiver decoder (IRD) for handling satellite television, a digital storage device, a digital media receiver, a digital media adapter, a streaming media device, a DVD player, a DVD recorder, a connected DVD, a local media server, a BLU-RAY player, a BLU-RAY recorder, a personal computer, a laptop computer, a tablet computer, a WebTV box, a personal computer television, a PC media server, a PC media center, a hand-held computer, a stationary telephone, a personal digital assistant, a mobile telephone, a portable video player, a portable music player, a portable gaming machine, a smart phone, or any other television equipment, computing equipment, or wireless device, and/or combination of the same.

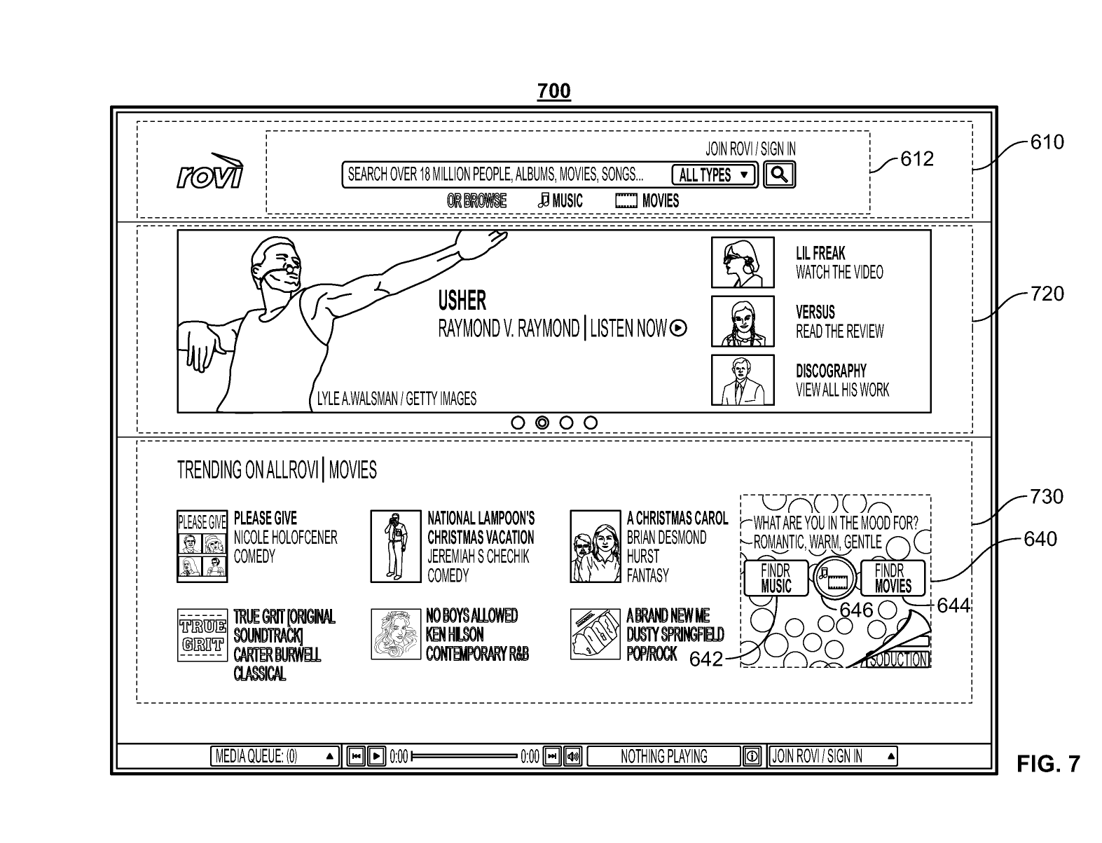

Turning to FIGS. 6 and 7, FIGS. 6 and 7 show illustrative display screens of a media guidance application that may be used to provide a user with guidance for various types of media content in accordance with some embodiments of the invention. As shown in FIG. 6, control circuitry 304 may cause a guidance display 600 to be divided into a plurality of regions, where each region provides a different mechanism for accessing media content. In particular, guidance display 600 includes a first region 610 that provides a general searching tool 612, a second region 620 that provides an advertorial, and a third region 630 that provides access to specific media content and access to a content selection tool 640.

It should be noted that, although guidance display 600 of FIG. 6, guidance display 700 of FIG. 7, and other display screens described herein are generally described as containing three regions, this is merely illustrative. For example, control circuitry 304 may provide a guidance display that includes any suitable number of regions (e.g., a region for each media type). Moreover, each region of the guidance display may or may not provide a different mechanism for accessing media content. For example, control circuitry 304 may provide two regions, where one region provides access to content selection tool 640 for filtering movie assets and another region provides access to content selection tool 640 for filtering music assets.

Although not shown, it should be noted that guidance display 600 of FIG. 6, guidance display 700 of FIG. 7, and other display screens described herein may contain one or more advertisements (e.g., for media content, products, or services related or unrelated to other content displayed on the display screen).

In some embodiments, first region 610 may include general searching tool 612. Control circuitry 304 may provide general searching tool 612 to, for example, allow a user to search for people (e.g., actors, actresses, artists, etc.), albums, movies, songs, compositions, television shows, and/or any other media content or entertainment information. As shown, control circuitry 304 may provide general searching tool 612 using a single text box or input element. This input element is thus capable of handling input related to various kinds of media or media-related information. As described further below, the search results may be context-sensitive, providing the user with the most relevant information and/or dividing different results by media type. For example, in response to receiving search terms in the input element of general searching tool 612, control circuitry 304 may search through metadata or other media guidance data for media content or information with metadata matching one or more of the search terms.

It should be noted that the input element of general searching tool 612 combines media content search capability with entertainment information search capability. As such, a single input element is provided that can return media content or information about media content as well as entertainment information related to, for example, an entertainer. In some embodiments, the search capability of general searching tool 612 contains context-sensitive functionality to recognize the type of information or content requested by the user.

It should also be noted that, in some embodiments, the input element of general searching tool 612 may be combined with other searching and/or filtering tools described herein. For example, in response to receiving one or more search terms in general searching tool 612, control circuitry 304 may provide the user with additional searching and/or filtering tools while limiting the search results to the one or more received search terms. In a more particular example, in response to the user entering the phrase “The Simpsons” in the input element of general searching tool 612, control circuitry 304 may limit the media content presented in a search results region by media content relating to “The Simpsons” and assist the user to select “The Simpsons”-related media content for consumption (e.g., music tracks played on “The Simpsons, downloadable episodes of “The Simpsons,” past or upcoming movies for “The Simpsons,” or information on actors or actresses that make guest appearances on “The Simpsons”).

Alternatively, as also shown in general searching tool 612 within first region 610, general searching tool 612 may allow the user to limit the search results to media content or information of a particular type. For example, by selecting the drop down box labeled “all types” in general searching tool, the user may specify the type of search desired. In response, control circuitry 304 may search for the desired type of content, such as movie content, music content, video content, all content, etc. In a more particular example, the user may specify that the search is for one or more of people, albums, movies, songs, compositions, television shows, or any other suitable media content or entertainment information.

In some embodiments, general searching tool 612 may include a browse option that allows the user to browse different categories of media content or related information. It should be noted that, although the general searching tool 612 in FIGS. 6 and 7 provide browse options for music content and movie content, any suitable number of browse options may be displayed for any number of categories.

In some embodiments, second region 620 may include an advertorial. As referred to herein, an advertorial is a combination of an advertisement and related editorial information. For example, an advertorial may present information pertaining to a person, a movie, a television show, an album, a song, a composition, or any other media content or related information. In some embodiments, the advertorial may be interactive. For example, the advertorial may provide the user with access to a video clip or preview (e.g., a movie trailer), an audio clip (e.g., a clip of a music track), and/or information related to the media content, person, or information being promoted (e.g., reviews, synopsis, cast information, etc.), or the media content itself. In another example, the advertorial may present and provide access to media content related to the media content being promoted. It should be noted that the advertorial may be the featured content on the display screen as opposed to an advertisement that is often displayed alongside, but secondary to, featured content. In providing one or more advertorials, the user may not be able to discern whether the media content featured in the advertorial is being promoted by an advertiser.

In some embodiments, the advertorial may cycle through a plurality of advertorials such that a different advertorial is displayed after a predetermined amount of time (e.g., every five seconds). After control circuitry 304 has displayed a sequence of advertorials, the rotation sequence may return to the first advertorial in the sequence. As shown in FIG. 6, the advertorial is promoting the actor “Jeff Bridges” and provides access to a trailer for the movie “iron Legacy.” The advertorial also provides access to media content and information related to or featuring Jeff Bridges. As shown, a trailer or a video clip for the movie “True Grit,” a review for the album “Be Here Soon,” and information corresponding to a filmography of the actor are provided within the advertorial. Turning to FIG. 7, the first advertorial promoting the actor “Jeff Bridges” in second region 620 from FIG. 6 may cycle to a second advertorial promoting the music artist “Usher” in second region 720. Similar to the advertorial of FIG. 6, the advertorial within second region 720 provides an audio clip from a music album that may be played directly from the advertorial as well as access to media content and information related to or featuring the music artist “Usher” (e.g., a related music video, a review of an album, and discography information).

In some embodiments, control circuitry 304 may allow the user to control which advertorial in a sequence of advertorials is displayed. For example, control circuitry 304 may provide selectable advertorial sequence indicators within second region 620 or 720 (e.g., located below the advertorial) that allow the user to select which advertorial is displayed.

In some embodiments, third region 630 of FIG. 6 or third region 730 of FIG. 7 may provide the user with access to trending media content. Trending media content may include, for example, movies, music, or other media content currently of interest to other users (e.g., other website users, most downloaded by users in a given period of time, etc.). Trending media content may be a selection of media content receiving the most selections compared to other media content that is available. For example, media content may be designated as trending media content based on traffic and visitor behavior and, in some embodiments, may be updated in real-time. As shown in FIGS. 6 and 7, the music album “Best Night of My Life” by Jaime Foxx is an example of a trending music album in third region 630 and the movie “Please Give” is an example of a trending movie in third region 730.

It should be noted that any suitable approach for determining the popularity or trending of media content may be used to select media content for display in the trending region. For example, the media content displayed in the trending region of region 630 or 730 may be media content of particular interest to a user, e.g., based on the user's profile or usage history.

As with the advertorial, control circuitry 304 may cycle or alternate with time the content displayed in the trending region of region 630 or 730. For example, control circuitry 304 may cause trending movies to be displayed, followed by trending albums, followed by additional trending movies, followed by additional trending albums, etc. In some embodiments, control circuitry 304 may allow the user to customize the content displayed in the trending region. Moreover, in some embodiments, the trending region may contain active media identifiers (e.g., highlighted thumbnails) and inactive media identifiers (e.g., thumbnails that are greyed out or not highlighted). As the content cycles through region 630 or 730 for given periods of time, the row of inactive media identifiers may replace the row of active media identifiers in the top row (as shown) and other inactive media identifiers may replace the previous row of inactive media identifiers.

In some embodiments, third region 630 of FIG. 6 or third region 730 of FIG. 7 may provide the user with access to content selection tool 640. Content selection tools 640 may provide the user with access to tools for finding music or movies (or other media content) based on user-defined criteria. For example, as shown in third region 630 of FIG. 6 and third region 730 of FIG. 7, content selection tool 640, which is indicated by “findR,” assists the user in selecting content for consumption from the guidance display. In a more particular example, control circuitry 304 may configure content selection tool 640 to include a music selection option 642 that provides the user with guidance for selecting music content, a movie selection option 644 that provides the user with guidance for selecting movie content, and a content selection option 646 that provides the user with guidance for selecting any suitable content (e.g., both music content and movie content). Content selection tool 640 is sometimes referred to herein as the “findR” tool. The findR tool is described in further detail below.

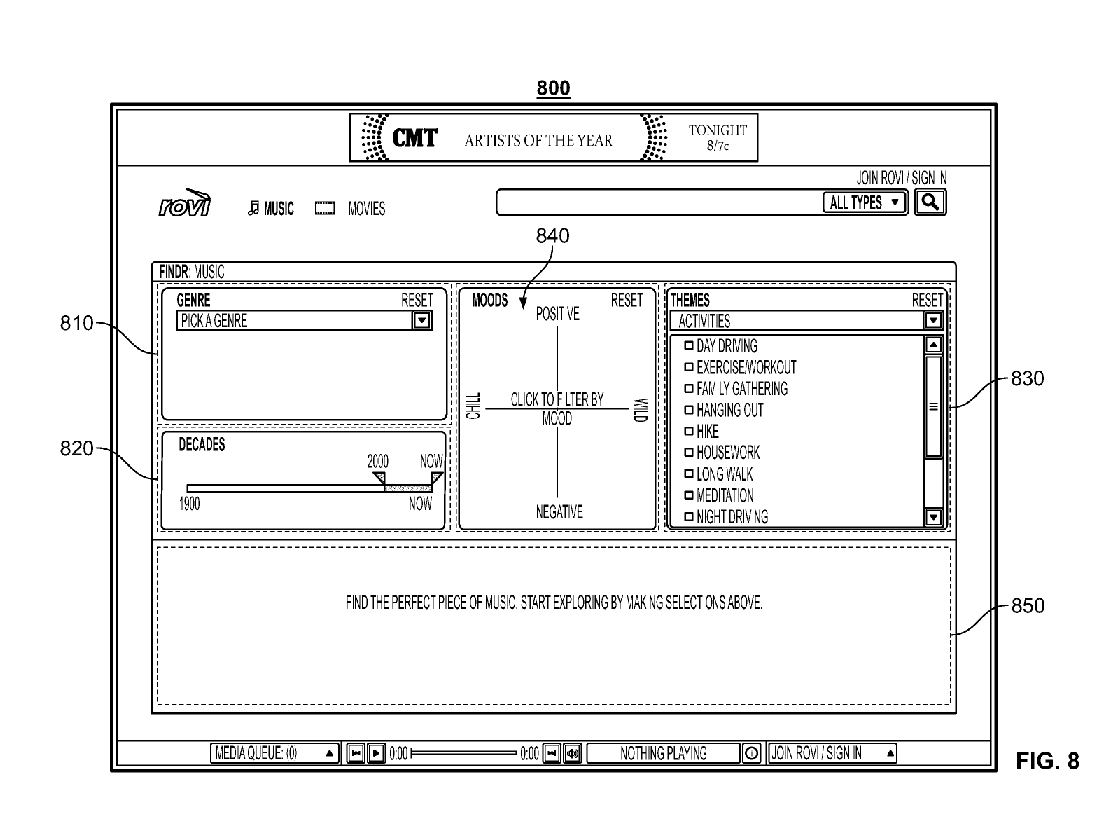

In response to receiving an indication that the user has selected a content selection tool, such as music selection option 642, control circuitry 304 may generate a display screen of a music selection tool for providing the user with guidance for selecting music content. FIGS. 8-13 show an illustrative display screen of a media guidance application that may be used to search and/or filter music or other audio content in accordance with some embodiments of the invention.

Turning to FIG. 8, initial display screen 800 may provide the user with various criteria. For example, as shown in FIG. 8, display screen 800 may include a category and/or subcategory filters 810, a decades filter 820, a themes filter 830, and a two-dimensional selection region 840. In particular, the user may instruct control circuitry 304 to filter the content that appears in a content results region 850 by genre (e.g., blues, classical, holiday, rock, rap, etc.), and, in some embodiments, a subgenre (e.g., acoustic blues, country blues, folk blues, modern blues, blues gospel, etc.) using category and/or subcategory filters 810. The user may also instruct control circuitry 304 to filter the content that appears in content results region 850 by selecting a time period (e.g., restricting the content to decade during which the content was released) using decades filter 820, a theme (e.g., an activity, such as exercising) using themes filter 830, and/or a mood (e.g., positive, negative, wild, chill, etc.) using two-dimensional selection region 840. In response to receiving one or more user-selected criteria, control circuitry 304 may filter content to provide search results associated with metadata that match the user-selected criteria. Content selection tool 640 or the findR tool provides a flexible and sensitive selection feature that allows users to find content, such as music content or movie content, that suits a particular and, in some cases, momentary taste.

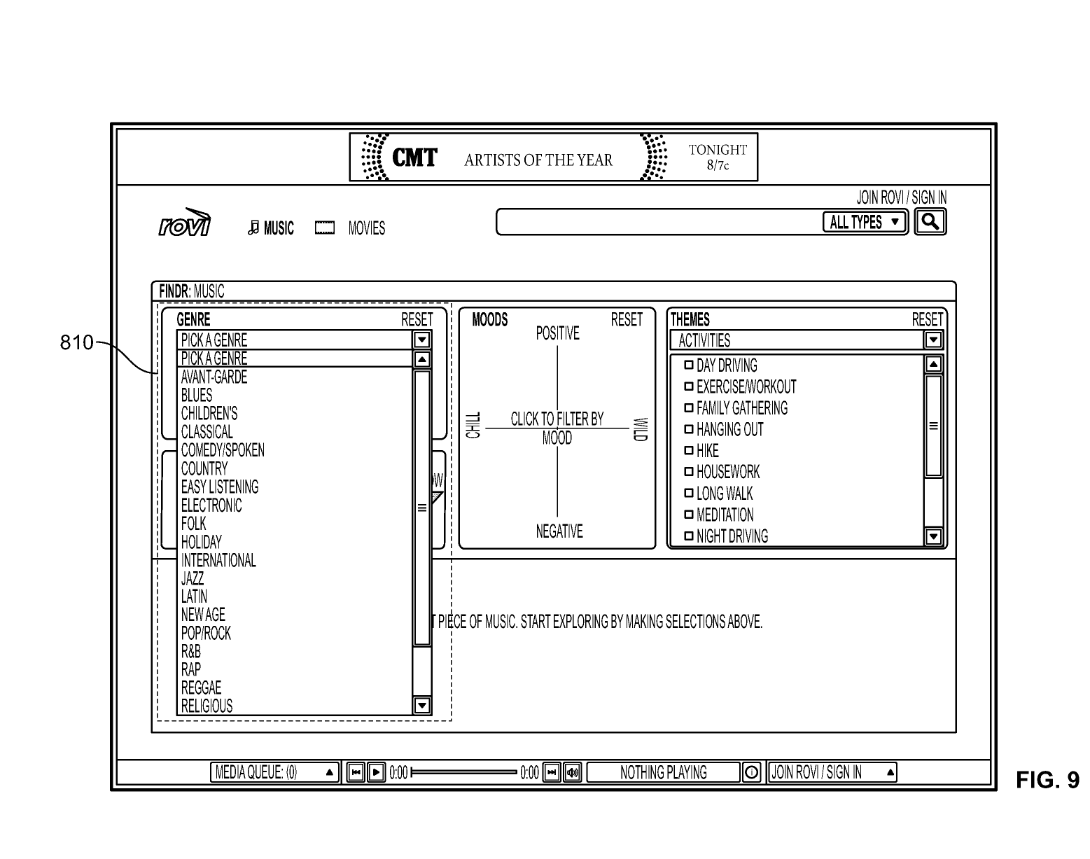

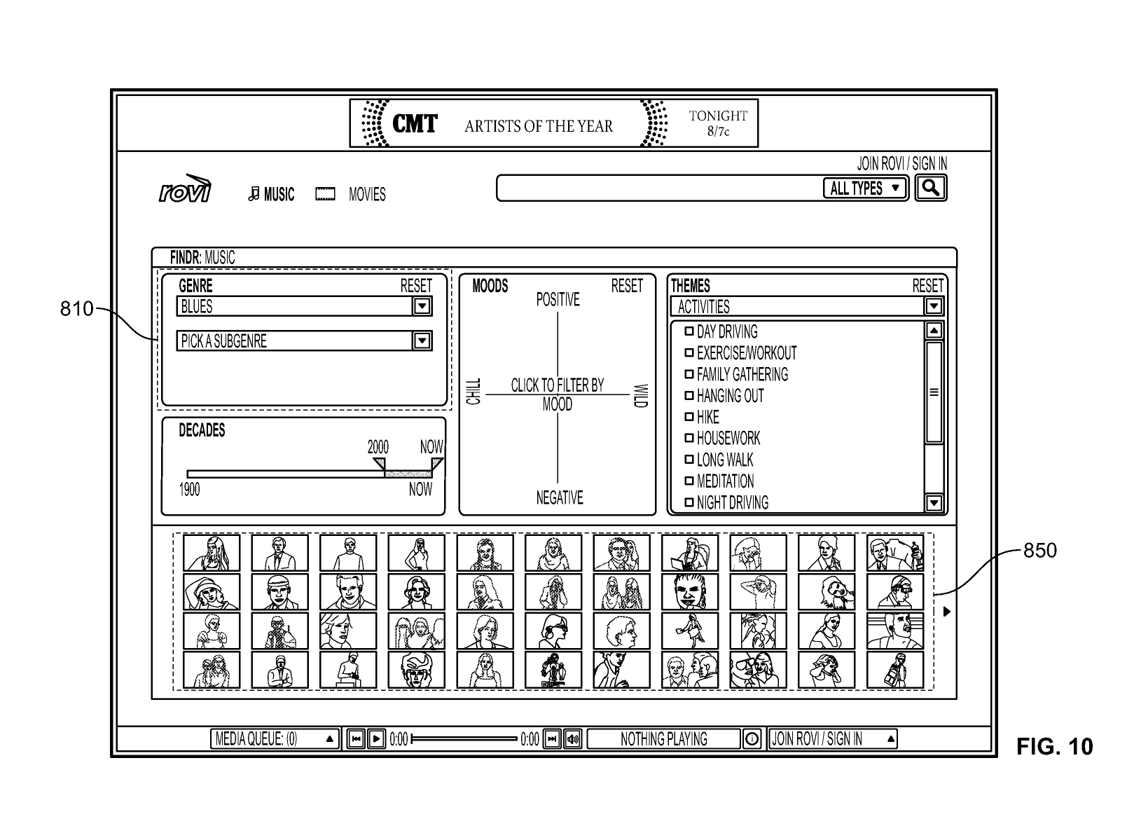

In some embodiments, category and/or subcategory filters 810 may allow the user to instruct control circuitry 304 to filter content by genre, subgenre, or any other suitable category of interest. FIG. 9 shows an example of the various genres that may be selected by the user with category filter 810. In particular, category filter 810 in FIG. 9 includes music genres, such as blues, classical, country, easy listening, jazz, etc. In response to receiving a user-selected genre (e.g., blues) to search and/or filter music content, control circuitry 304 performs a search through content for metadata matching the user-selected genre and, as shown in FIG. 10, a plurality of media identifiers are displayed in search results region 850. Each of the media identifiers, which are displayed as thumbnails containing cover art in search results region 850, corresponds to media content (e.g., a music album, an audio track, a movie, a television program, video clips, games, etc.).

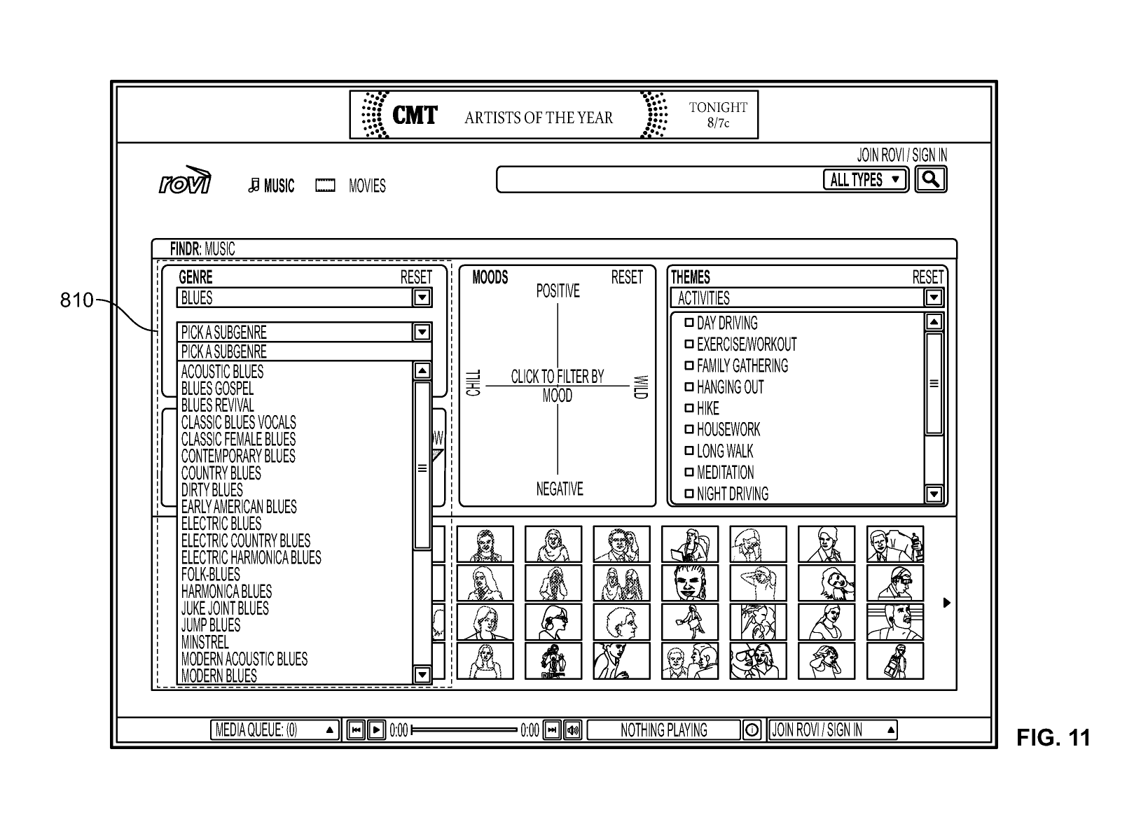

Turning to FIG. 11, control circuitry 304 may allow the user to continue to enter criteria for searching and/or filtering content in search results region 850. In FIG. 11, control circuitry 304 has activated a subcategory or subgenre filter in response to receiving a user selection for the category or genre filter shown in FIG. 9. In particular, in response to receiving a user selection for the category filter in region 810, control circuitry 304 may transmit a query to a database for subcategory information associated with the selected category. Upon receiving the subcategory information, control circuitry 304 may populate a drop-down list in region 810 for selection by the user. For example, as shown in FIG. 11, in response to the user selecting “Blues” in the category filter of FIG. 9, control circuitry 304 may provide the user with a drop-down list in region 810 of corresponding subcategories. The subcategories or subgenres associated with the blues music category may include, for example, blues gospel, contemporary blues, country blues, and harmonica blues.

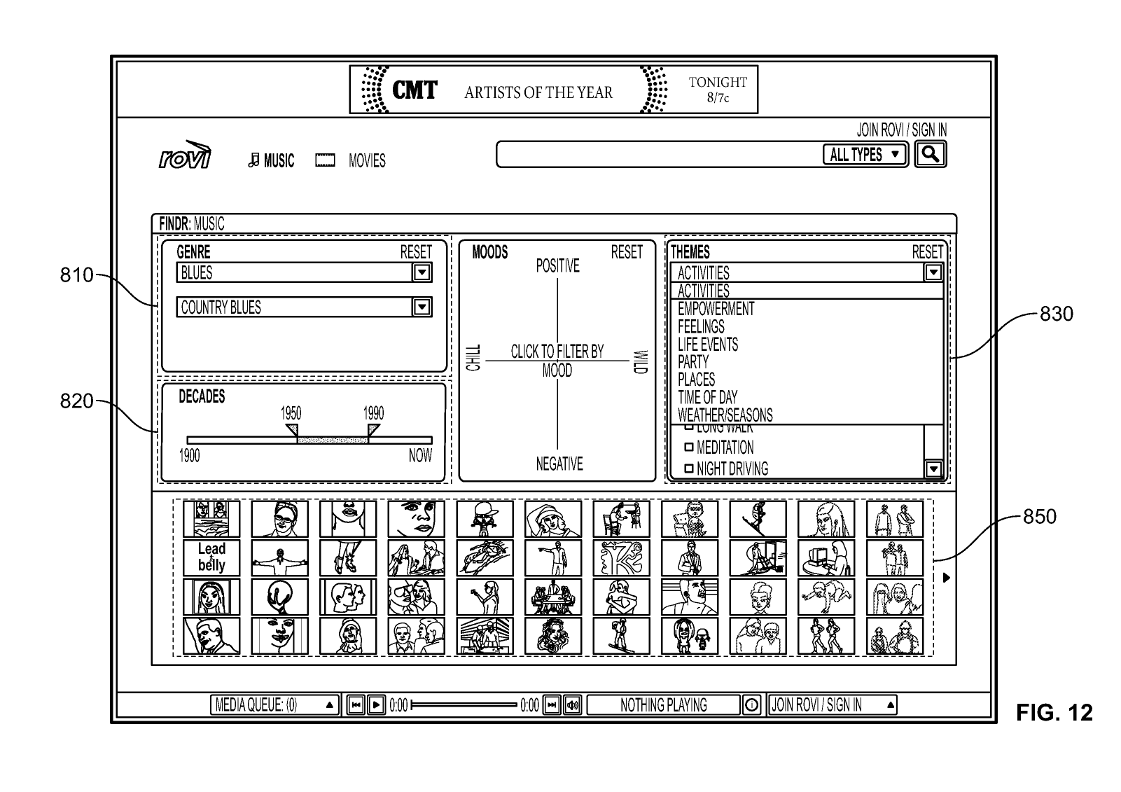

In response to receiving a subcategory or subgenre from the user in region 810, control circuitry 304 may refine the content provided in search results region 850. For example, control circuitry 304 may search through the metadata associated with the media content in search results region 850 to find media content that matches the updated criteria. In a more particular example, the media content provided in search results region 850 of FIG. 12 has metadata that matches the selected genre “blues” and the selected subgenre “country blues.”

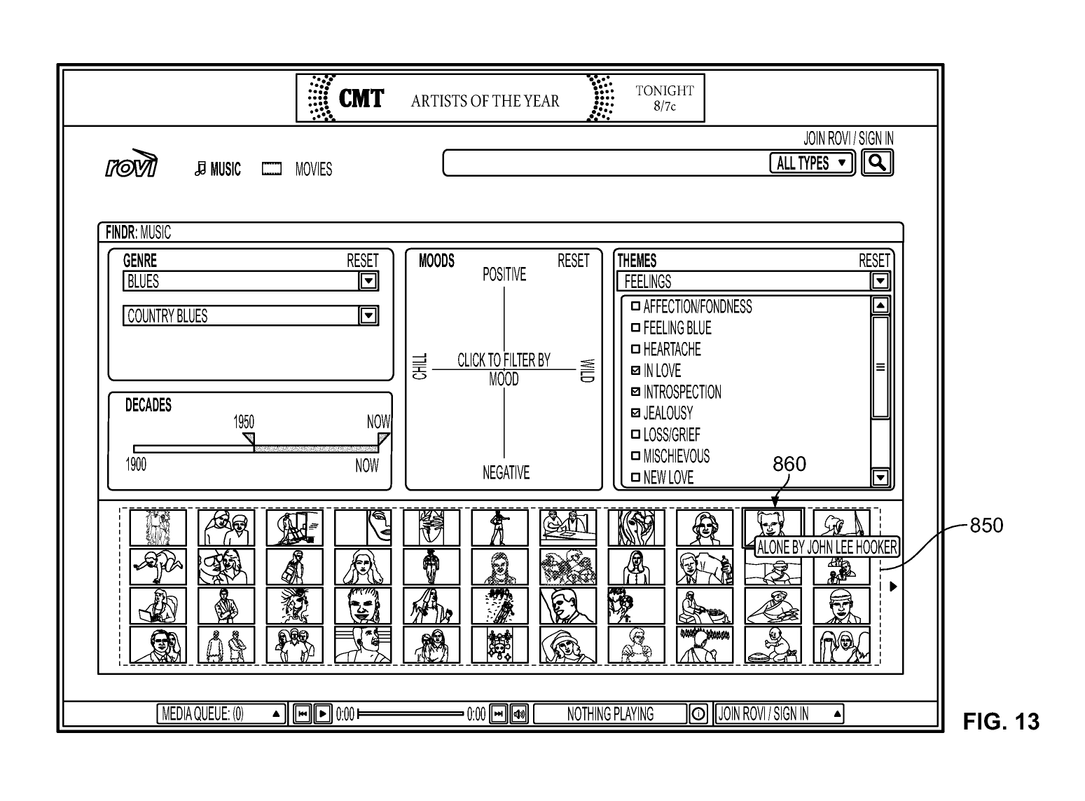

Additionally, FIGS. 12 and 13 shows that other filters may be used to further refine the content provided in search results region 850. As shown in FIG. 12, the time period of the music content may be defined by the user (e.g., 1950-1990) in decades filter 820. As the decades time period is modified by the user, control circuitry 304 may dynamically update the media content provided in search results region 850 to show only those albums matching the desired criteria, which includes the desired time period. As also shown in FIG. 12, the user may select a theme to filter the media content provided in search results region 850. A theme may be any contextual or environmental variable, such as an activity the user is doing, an emotion the user is feeling, or the weather at the user's location. In a more particular example, FIG. 12 shows that themes may be organized into categories, such as activities, empowerment, feelings, life events, party, places, time of day, and weather/seasons. For example, in response to receiving a user selection for theme filter 830, control circuitry 304 may transmit a query to a database for subcategory information associated with the selected theme. Upon receiving the subcategory information, control circuitry 304 may populate a drop-down list in region 830 for selection by the user. For example, as shown in FIG. 13, in response to the user selecting the theme “feelings” in theme filter 830 of FIG. 12, control circuitry 304 may provide the user with a drop-down list in region 830 of corresponding subcategories. The subcategories or subgenres associated with the “feelings” theme may include, for example, “feeling blue,” “heartache,” and “in love.”

In response to receiving one or more subcategories from the user in region 830, control circuitry 304 may refine the content provided in search results region 850. For example, in response to determining that the user has selected subcategory “exercise” under the theme “activity,” control circuitry 304 may update the content provided in search results region 850 such that albums, songs, and other music content matches the user-selected criteria, such as relating to exercise.

It should be noted that, in some embodiments, metadata associated with the albums, songs, and other content may include information on which themes (e.g., activities) the content is suitable for categorization.

It should be noted that control circuitry 304 may provide additional criteria for searching and/or limiting search results. For example, control circuitry 304 may include a rating filter (e.g., one star), a popularity or ranking filter, a demographics filter (e.g., toddler, high schooler, young adult, etc.), a film rating filter (e.g., PG-13, PG, R, etc.), etc.

In some embodiments, control circuitry 304 may allow the user to select one or more filters to provide in guidance display 800. For example, the user may request that theme filter 830 be replaced with a rating filter. In response, control circuitry 304 may retrieve from a database identifiers associated with the rating filter for population into display 800. In another example, control circuitry 304 may retrieve from a database a list of available filters for selection by the user. In response to receiving a selection of a filter from the user, control circuitry 304 may retrieve identifiers associated with the selected filter and present the retrieved filter and its associated identifiers in display 800.

Accordingly, the various search and filtering tools of content selection tool 640 may be used in combination to identify particular albums and/or songs the user desires (when searching for music content) or particular movies and movie-related content (when searching for movie content). For example, a genre and subgenre may be specified, a time period may be defined, and a number of emotions may be selected. The search results are thereby refined such that metadata associated with the content provided in the search results match the user-selected criteria.

In some embodiments, control circuitry 304 may connect the searching and filtering tools of content selection tool 640 with other portions of the media guidance application. For example, in response to the user inputting the name of an artist, such as “Wolfgang Amadeus Mozart” into general searching tool 612 in first region 610 of FIG. 6, control circuitry 304 may provide the searching and filtering tools of content selection tool 640 to identify particular albums and/or songs relating to the artist “Wolfgang Amadeus Mozart.” In this example, control circuitry 304 may allow the user input criteria (e.g., a sub-region from two-dimensional selection region, an activity, a particular mood, etc.) and use the user-selected criteria to filter music content relating to “Wolfgang Amadeus Mozart.” In another example, in mixed-media cases where the user is searching for any media content (whether audio content or video content), control circuitry 304 may also provide the user with movie content (e.g., the movie “Amadeus”), video-related content (e.g., video content where music by “Wolfgang Amadeus Mozart” is played), etc.

In response to entering and/or selecting from various criteria, control circuitry 304 may perform a search through content for metadata matching the user-selected criteria and, as shown in FIG. 13, a plurality of selectable media identifiers are displayed in search results region 850. For example, in response to navigating to a particular media identifier (e.g., a selectable media identifier 860) from the plurality of selectable media identifiers in search results region 850, control circuitry 304 may provide the user with text information associated with the media asset, such as the album title and artist name (e.g., “Alone” by John Lee Hooker).

In some embodiments, control circuitry 304 may monitor the navigation by the user. For example, when control circuitry 304 determines that the cursor is placed over selectable media identifier 860, control circuitry 304 may highlight or activate selectable media identifier 860 (e.g., increase the brightness of the thumbnail image) and provide the user with text information associated with the media asset (e.g., the album title and artist name).

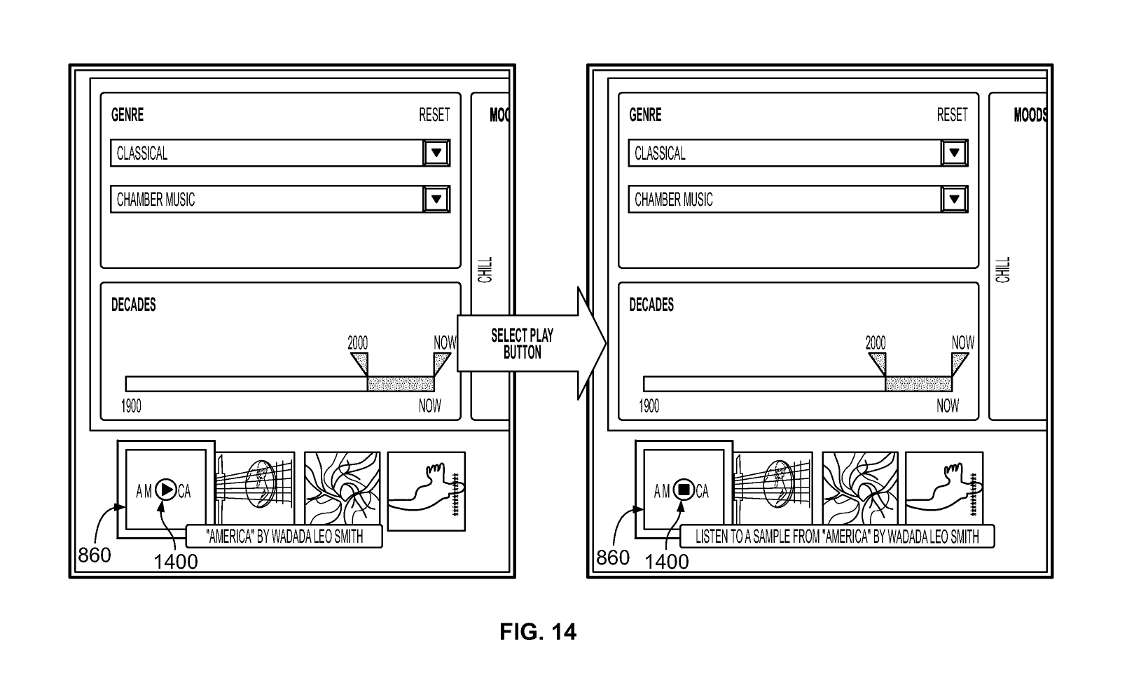

In some embodiments, control circuitry 304 may monitor the location with respect to a selectable media identifier. For example, control circuitry 304 may detect whether the location coordinates of a cursor are approaching the center of a selectable media identifier. As shown in FIG. 14, in response to determining that the cursor has been placed near the center of selectable media identifier 860, control circuitry 304 may activate a playback option 1400. Playback option 1400 may, for example, instruct control circuitry 304 to retrieve and/or play an audio clip, a full track from the music album, a sequence of audio clips starting at the first track of the music album, or any other suitable audio content via speakers 314.

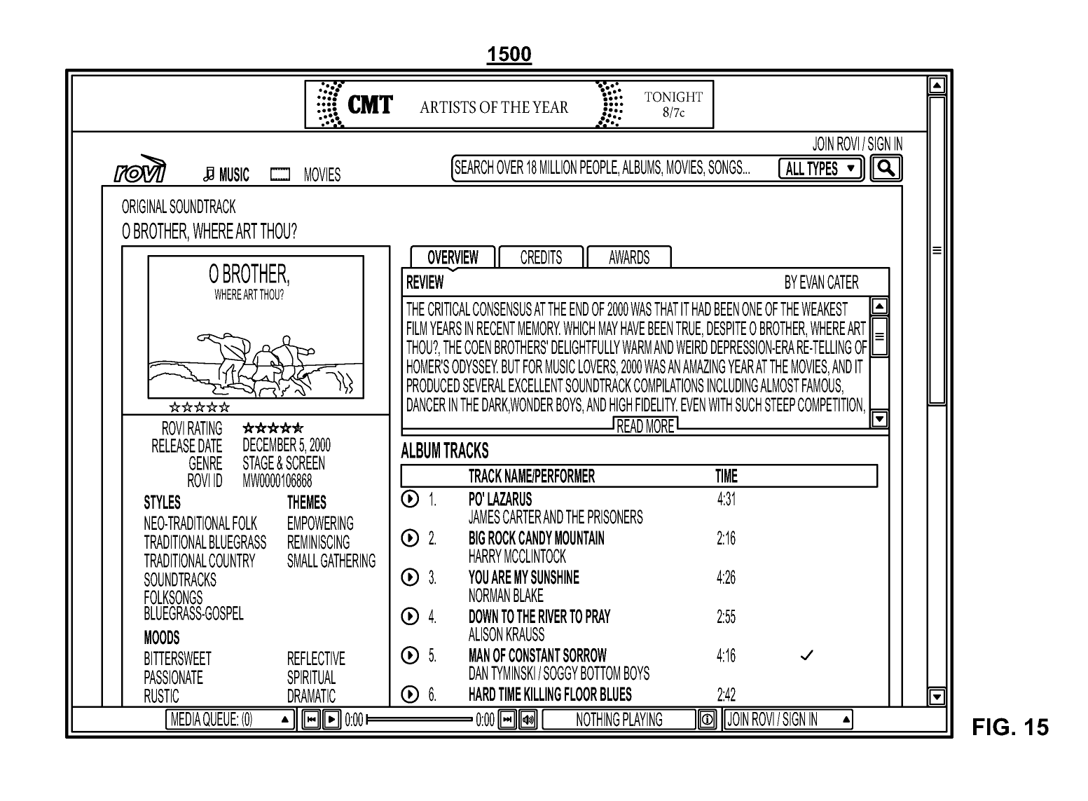

In some embodiments, in response to selecting selectable media identifier 860, control circuitry 304 may provide the user with access to additional information about the media content associated with the media identifier. For example, as shown in an illustrative media information display 1500 of FIGS. 15-18, in response to the user receiving a plurality of media identifiers after using content selection tool 640 and selecting a selectable media identifier corresponding to the music album “0 Brother, Where Art Thou?”, control circuitry 304 may provide the user with access to information and other media content associated with a particular album, song, or other audio content.

It should be noted that control circuitry 304 may cause media information display 1500 or any other suitable information display to be presented in response to, for example, selecting an album from trending media content section of third region 630 in FIG. 6, or inputting the album name or other identifying information into general searching tool 612 in first region 610 in FIG. 6.

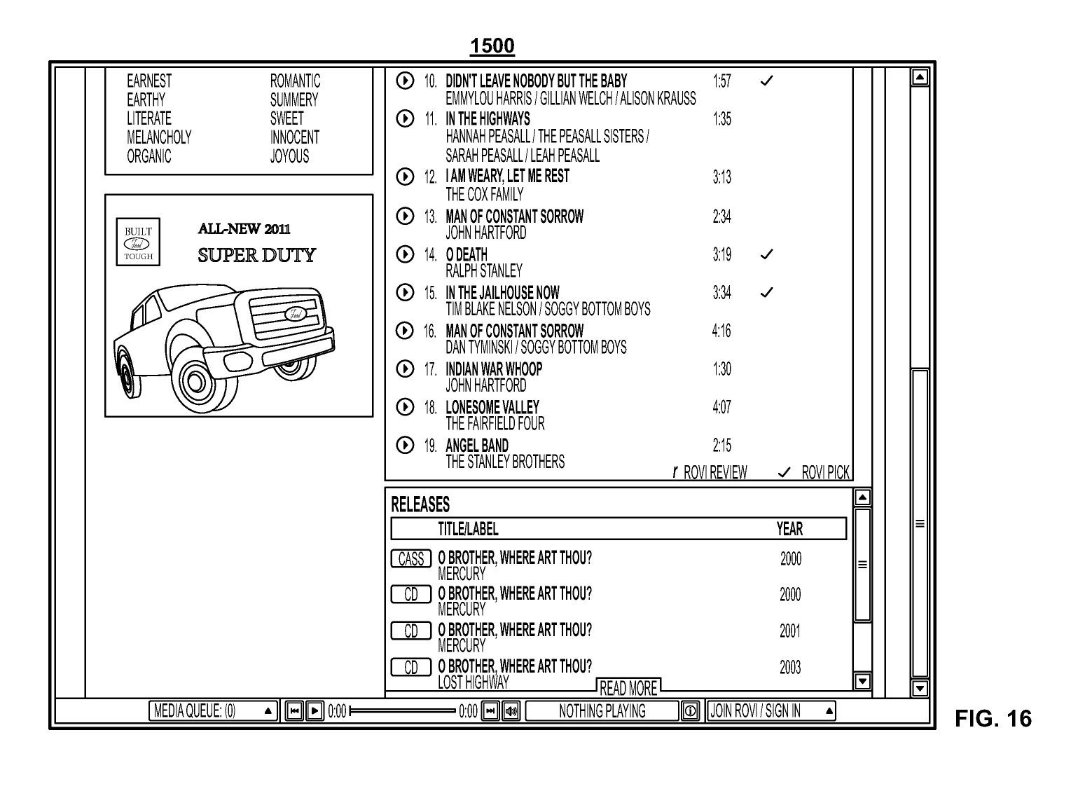

Referring back to FIGS. 15-18, media information display 600 may include reviews of the album, rating information, credit information, award information, and other pertinent information. For example, as shown in FIG. 16, different releases of the album may be displayed together with relevant information, such as the year of release. In some embodiments, control circuitry 304 may retrieve metadata associated with the selected media content and present portions of the metadata in media information display 600. For example, as shown in FIG. 15, media information display 600 includes the styles (e.g., neo-traditional folk, traditional bluegrass, etc.), themes (e.g., empowering, reminiscing, etc.), and moods (e.g., bittersweet, reflective, rustic, etc.) associated with the media content.

It should be noted that control circuitry 304 may retrieve metadata associated with the selected media content for presentation in display 600. In some embodiments, control circuitry 304 may aggregate and/or assemble the metadata associated with each song on a particular album for presentation in display 600. Additionally or alternatively, control circuitry 304 may transmit a query to other sources (e.g., media guidance data source 418, a social networking website, a music review website, etc.) to assemble the metadata for presentation in display 600.

As also shown in FIGS. 15-17, media information display 600 may also provide information on the album tracks (or songs). The tracks may be sampled by the user and/or added to a media queue. In some embodiments, control circuitry 304 may allow the user to select an individual track to access additional information related to the selected track. Additionally or alternatively, control circuitry 304 may allow the user to purchase and/or download the album or a particular track.

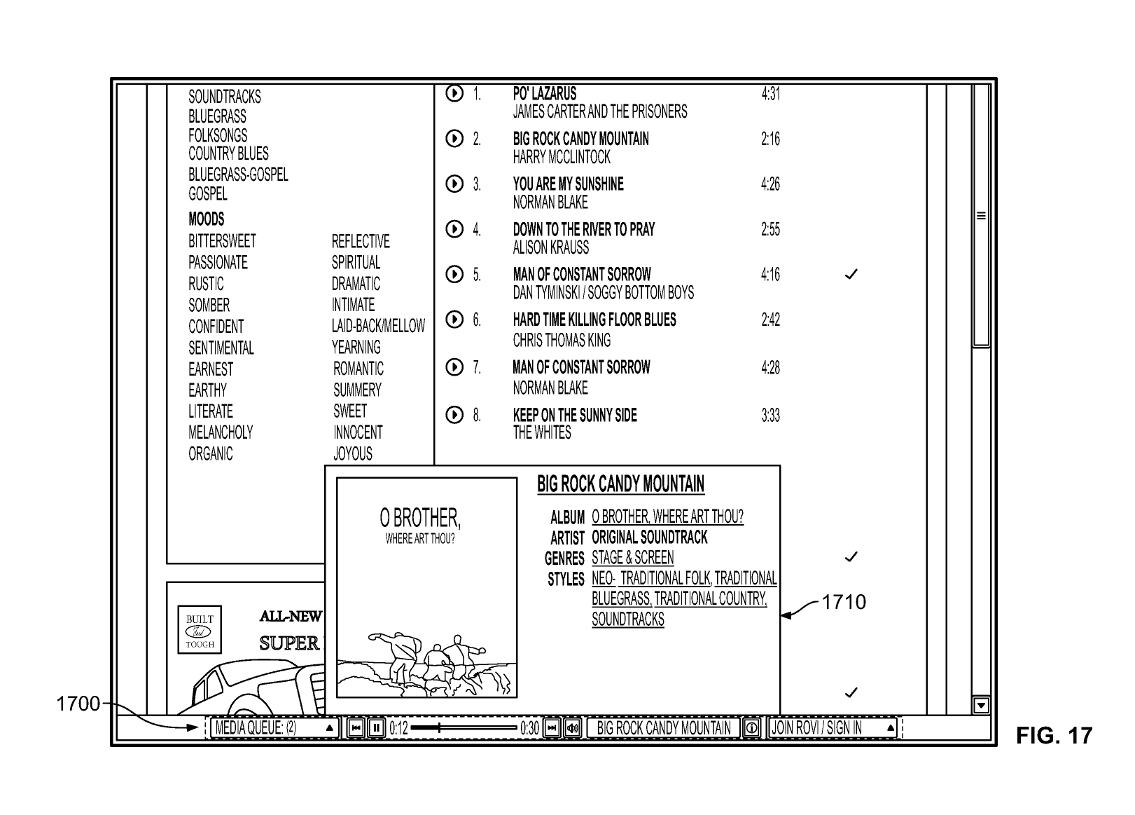

Turning to FIG. 17, control circuitry 304 may allow the user to add one or more pieces of media content (e.g., audio tracks) to a media queue 1700 for playback. Media queue 1700 may provide the user with media control tools for allowing a selected album or song to be played or queued for layer playing. As shown, media queue 1700 may play back a selected piece of media content while simultaneously displaying information related to a currently queued or playing song in overlay 1710. In particular, overlay 1710 may include information, such as the album title, song title, artist, genres, and styles. In some embodiments, overlay 1710 may be revealed or hidden as the user desires (e.g., user selection, user preferences, etc.). Alternatively, overlay 1710 may be minimized or hidden after being displayed for a predetermined period of time.

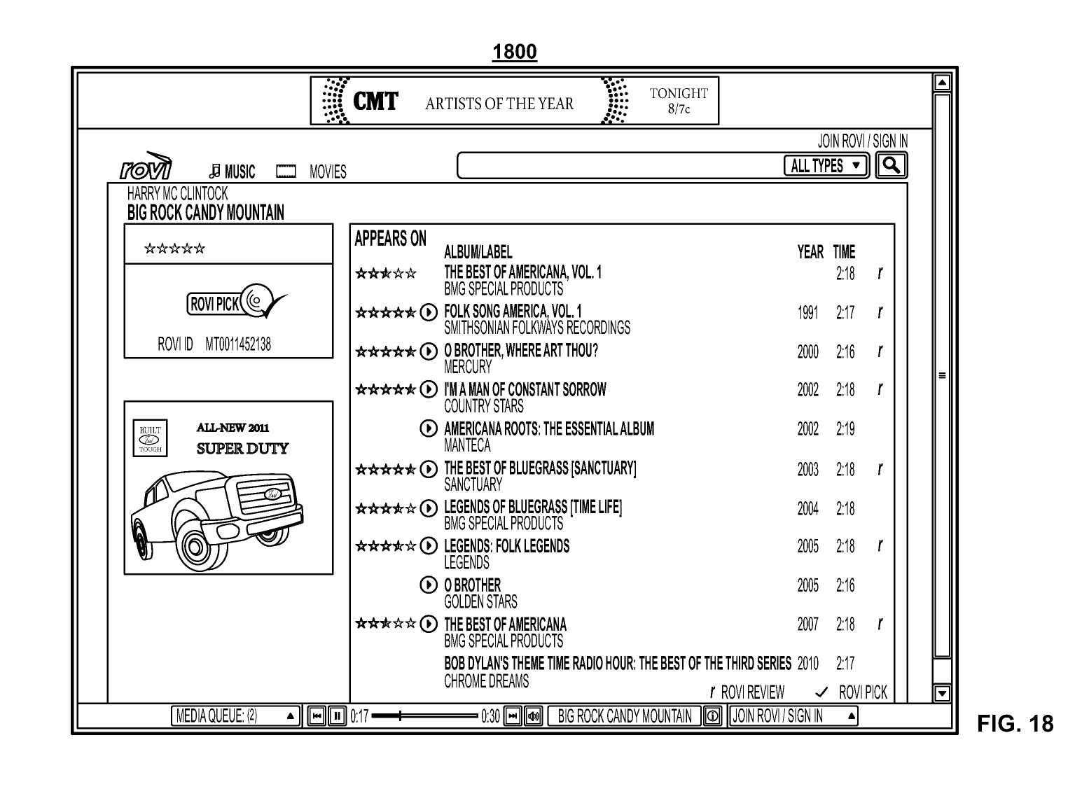

In response to selecting information from overlay 1710, control circuitry 304 may provide the user with information and other media content associated with a particular song (e.g., selected from the overlay of FIG. 17). For example, FIG. 18 shows that an illustrative media information display 1800 screen may list all albums on which the song appears, and may allow the user to play, queue, or sample the song on each album. This allows the user to quickly listen to different versions of the same song on different albums. Again, control circuitry 304 may provide a persistent media queue. Once a song, video, or other content is queued or playing, the media guidance application may allow the user to navigate to other display screens without interrupting the playing and/or without erasing the queue. Accordingly, the media queue and its control tools may persist throughout the media guidance application, allowing the user to play or add media content to the media queue as the user browses through the display screens of the media guidance application.

It should be noted that, in some embodiments, control circuitry 304 may cause any suitable action to be performed in response to selecting a media identifier (e.g., media identifier 860 of FIG. 13). For example, additionally or alternatively to accessing information relating to the content corresponding to the selected media identifier, control circuitry 304 may provide the user with the opportunity to preview the content, record the content, set a reminder to listen to or watch the content, etc.

Referring back to FIG. 8, content selection 640 may also include two-dimensional selection region 840 for searching and/or filtering media content provided in search results region 850. In response to selecting a portion within two-dimensional selection region 840, control circuitry 304 may search through media content with metadata matching or corresponding to the selected portion within two-dimensional selection region 840.

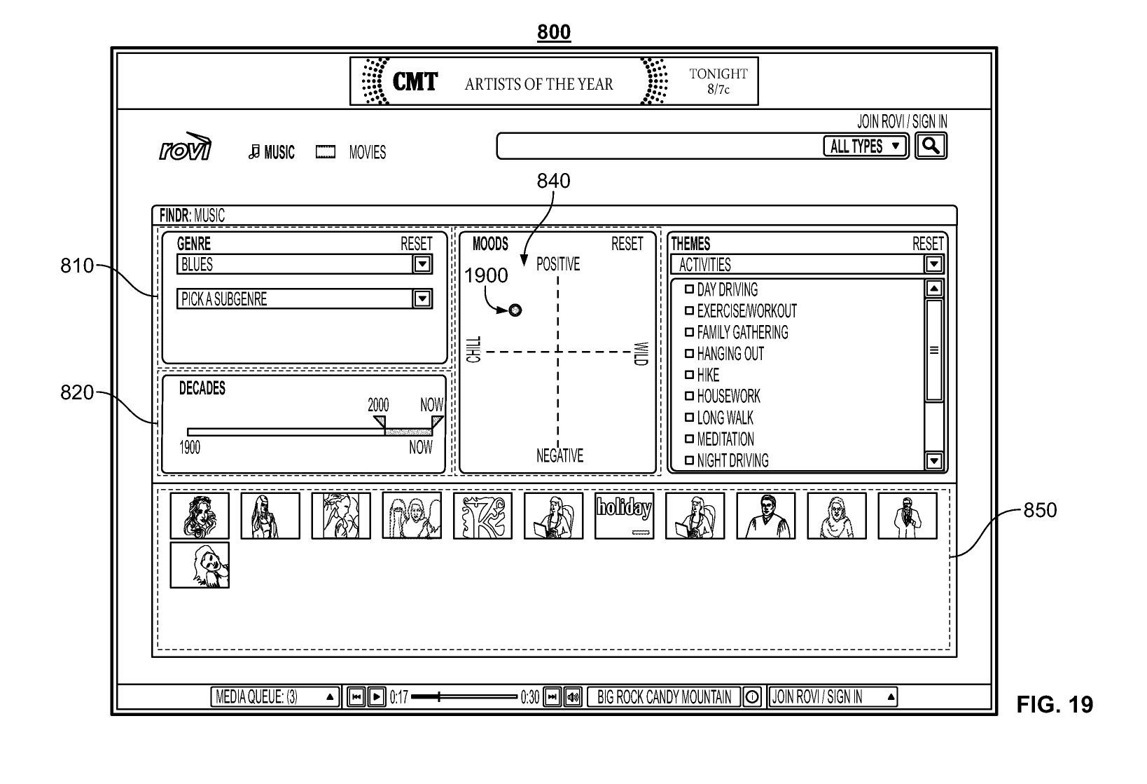

FIG. 19 shows an illustrative display screen 800 that may be used to search and/or filter music or other audio content based on criteria, such as moods, in accordance with some embodiments of the invention. In particular, along with the other filters and filtering tools described above, content selection tool 640 may limit the search results to those associated with one or more moods indicated by the user in two-dimensional selection region 840.

In some embodiments, two-dimensional selection region 840 may allow the user to graphically indicate which, and how much, of each mood to take into account when selecting media content. For example, two-dimensional selection region 840 may a vertical axis and a horizontal axis. The vertical axis and the horizontal axis may each have a lower bound or extreme and an upper bound or extreme. For example, as shown in FIG. 19, the vertical axis of two-dimensional selection region 840 allows the user to indicate a desire for “positive” music content (the upper bound) or “negative” music content and the horizontal axis of two-dimensional selection region 840 allows the user to indicate a desire for “wild” music content (the upper bound) or “chill” music content (the lower bound). The user may provide an indication of degree between two bounds for each of the moods. For example, as shown in FIG. 19, the user has selected point 1900 in two-dimensional selection region, which may be used to select media content that is more towards a “positive” mood than a “negative” mood and more towards a “chill” mood than a “wild” mood.

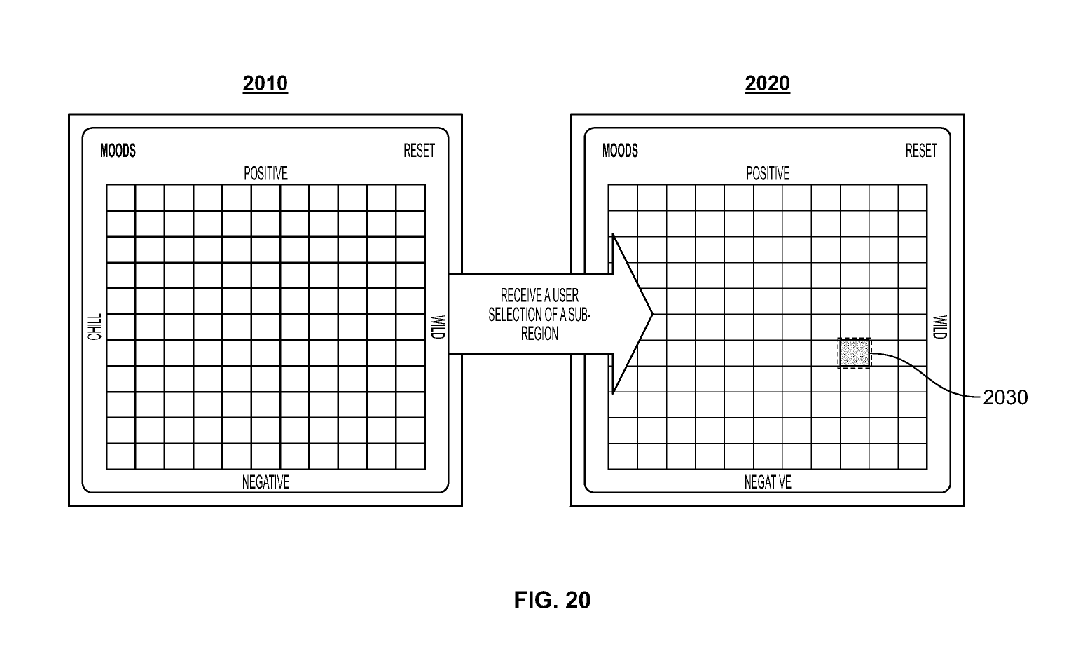

In some embodiments, control circuitry 304 may cause the two-dimensional selection region to be divided into a plurality of sub-region. For example, as shown in a two-dimensional selection region 2010 of FIG. 20, control circuitry 304 divides two-dimensional selection region 2010 into a grid of evenly spaced, square cells. Alternatively, although the two-dimensional selection regions shown in FIG. 20 are shown as a grid that is divided into a plurality of square sub-regions, this is merely illustrative. For example, in some embodiments, control circuitry 304 may divide the two-dimensional selection region into a plurality of non-uniform regions (e.g., circular regions of varying diameter).

In some embodiments, the two-dimensional selection region may define an intersection between a first criterion and a second criterion. For example, as shown in FIG. 20, two-dimensional selection region 2010 defines an intersection between a first mood between “positive” and “negative” and a second mood between “wild” and “chill.” It should be noted that the positive-negative and chill-wild sets of moods are exemplary only and that control circuitry 304 may provide any suitable criterion on the axes of two-dimensional selection region 2010. For example, a two-dimensional selection region may define the intersection between a mood, which has a “positive” mood upper bound and a “negative” mood lower bound, and a parental guideline, which has a “mature audiences only” upper bound and a “kid friendly” lower bound.

In some embodiments, control circuitry 304 may allow the user to select and/or define criterion for placement on the two-dimensional selection region. For example, in some embodiments, control circuitry 304 may provide the user with a list populated with criterion information from database. The user may indicate criterion for placement on the two-dimensional selection region using the criteria list. In another example, in some embodiments, control circuitry 304 may provide the user with an opportunity to define or create criteria for customized two-dimensional selection regions. In response, control circuitry 304 may search through metadata for content that best matches the user-defined criteria.

Referring back to FIG. 20, as shown in two-dimensional selection region 2020, control circuitry 304 may receive a user selection 2030 of one of the cells in the grid. In this example, in response to receiving a user selection 2030 of a square sub-region from the grid in two-dimensional selection region 2020, control circuitry 304 may transmit a query to a database for media content with metadata matching user selection 2030. In a more particular example, control circuitry 304 may transmit a query to a database for media content using portions of information derived from user selection 2030—e.g., find media content with corresponding metadata that is at least 82% wild and 18% chill on the chill-wild mood scale (where chill is 0% and wild is 100%) and that is at least 54% negative and 46% positive on the negative-positive mood scale.

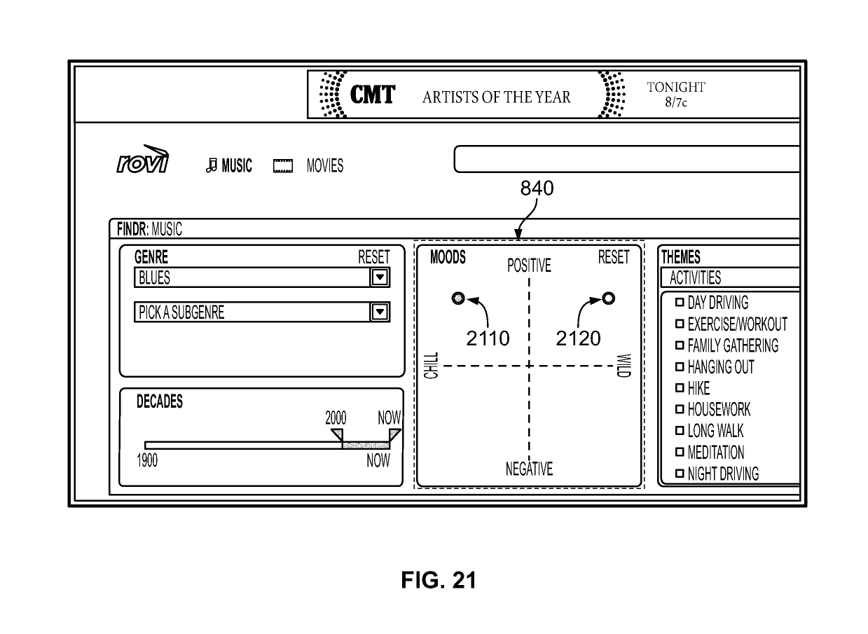

Another illustrative example of receiving a user selection in a two-dimensional selection region is shown in FIG. 21. The extent of a mood may be indicated by selecting an area on or near an axis of the desired mood. For example, a user may set how wild or chill the music should be by selecting a location on the chill-wild axis. The closer to “chill” the user selects, the more chill the music, while the closer to “wild” the user selects, the more wild the music. Similarly, the user may indicate how positive or negative the music should be by selecting a point on the positive-negative axis. A combination of moods may be indicated by selecting a point within the two-dimensional space created by the intersecting axes. For example, a point 2110 selected by the user indicates that the music content should be both very positive and very chill. The center of the intersecting axes indicates that the music content should be neither very chill nor very wild, nor should it be very positive or very negative. On the other hand, a point 2120 selected by the user indicates that the music content should be both very positive and very wild.

In some embodiments, control circuitry 304 may provide the user with multiple two-dimensional selection regions in a guidance display. For example, control circuitry 304 may provide the user with a selectable list of available two-dimensional selection regions. In a more particular example, the user may be provided with a first two-dimensional selection region that defines an intersection between a first mood and a second mood, a second two-dimensional selection region that defines an intersection between a third mood and a fourth mood, and a third two-dimensional selection region that defines an intersection between a rating and a theme. Control circuitry 304 may sequentially filter media content for presentation to the user in response to a user providing a user selection of a sub-region from each two-dimensional selection region. Alternatively, control circuitry 304 may collect and/or combine the user selections from the multiple two-dimensional selection regions and create a single query to the database—e.g., retrieve media content with corresponding metadata that is at least 82% wild and 18% chill for the chill-wild set of moods, at least 54% negative and 46% positive for the negative-positive set of moods, at least 80% bright and 20% dark for the bright-dark set of moods, at least 80% comedy and 20% romantic on the set of romantic-comedy themes, etc.

In some embodiments, control circuitry 304 may modify and/or update the two-dimensional selection region. For example, the criteria placed on the axes of the two-dimensional selection region may change based on other criteria selected by the user, user history information, user profile information, etc. In a more particular example, control circuitry 304 may determine that the user prefers “positive” music and, in response, may remove the positive-negative set of moods from the two-dimensional selection region and provide a different set of moods.

In response to retrieving music content matching the user-selected criteria (e.g., using the two-dimensional selection region), control circuitry 304 may present the user with a plurality of media identifiers associated with the retrieved media content in search results region. For example, control circuitry 304 may provide an indicator that follows the cursor directed by the user as the user moves the cursor around the two-dimensional selection region defined by the mood axes (or other criteria axes). In response to receiving a mouse click on a particular point in the two-dimensional selection region, control circuitry 304 may display a point indicator of the user selection (e.g., points 2110 and 2120) and update the search results based on the user selection. In response to determining that the user has made another selection on another area, control circuitry 304 moves the point indicator to the new position and updates the search results accordingly.

In some embodiments, control circuitry 304 may dynamically update the media content and their media identifiers presented in search results region as the user moves through the two-dimensional selection region. For example, as shown in FIG. 19, in response to detecting that the cursor has navigated within two-dimensional selection 840 (“mood space”), control circuitry 304 may dynamically update the media content and their media identifiers presented in search results region 850.

In some embodiments, control circuitry 304 may provide a two-dimensional selection region that indicates where media content is available with shading, coloring, or other indicators. For example, an area within the lower right quadrant of the mood space in FIG. 21 may be shaded to indicate that wild and negative music is available. In another example, coloring and/or shading may indicate the amount of music available in any given area of the mood space. In a more particular example, the mood space may be lightly shaded in certain areas to indicate the availability of relatively few songs, and may be heavily shaded in other areas to indicate the availability of a relatively large number of songs. Thus, control circuitry 304 provides a two-dimensional selection region that allows the user to quickly determine whether music content is available and how much music content is available for a desired mood or combination of moods.

It should be noted that, in some embodiments, control circuitry 304 may allow the user to provide multiple user selections within the two-dimensional selection region. For example, as shown in FIG. 21, in response to selection points 2110 and 2120, control circuitry 304 may retrieve search results that match the criteria associated with point 2110 and search results that match the criteria associated with point 2120.

Accordingly, the two-dimensional selection region provides an interactive and easy-to-use tool that allows the user to quickly and efficiently indicate one or more moods or any other suitable criteria, and the extent of such moods. User selections from the one or more two-dimensional selection regions is then used to search through metadata and other content information for music content to determine or filter through search results of music content matching the user-selected criteria.

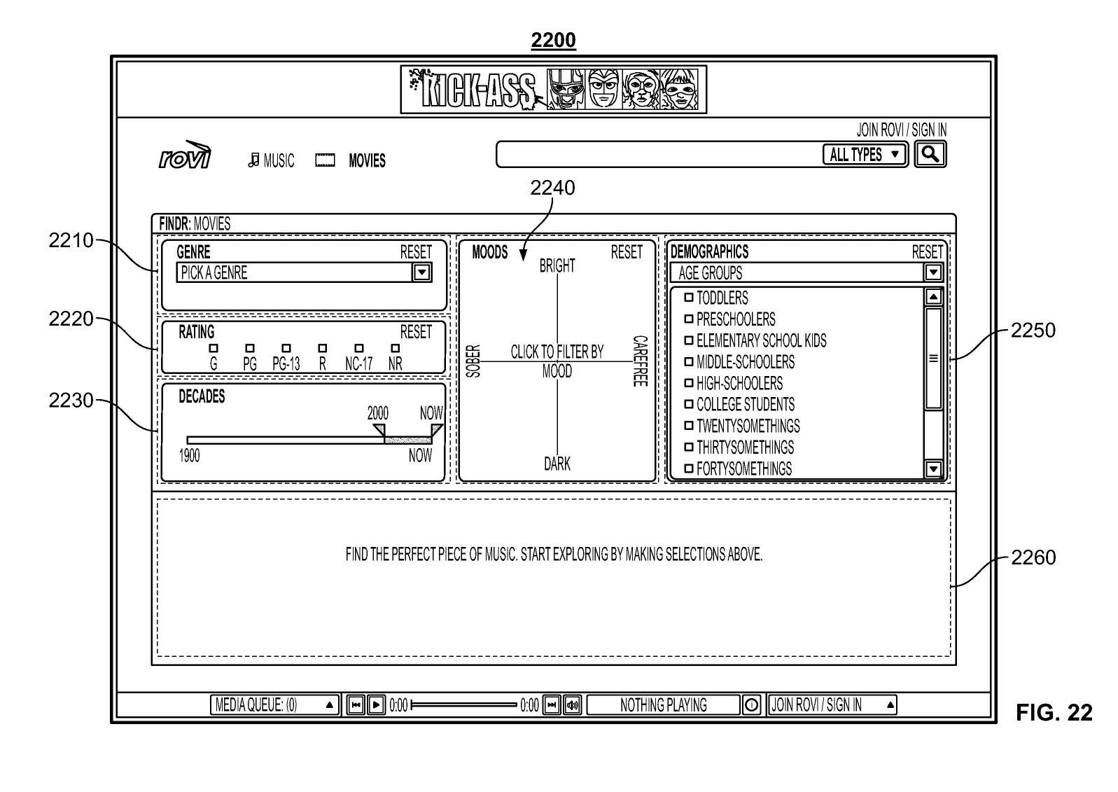

Although FIGS. 8-21 generally describe embodiments directed towards searching and/or filtering music content, there are merely illustrative. The media guidance application may provide the user with guidance for searching and/or filtering any suitable media content. For example, FIGS. 22-27 show illustrative media guidance display screens that may be used to search and/or filter movie content and/or other video content in accordance with some embodiments of the invention. In particular, FIGS. 22-27 illustrate the content selection tool or findR tool to search for movies, television shows, or other video content. As shown, the findR tool for searching or filtering video content may be similar to the findR tool for searching or filtering music content described above in connection with FIGS. 8-21.

Turning to FIG. 22, in addition to a category and/or subcategory filter 2210, a decades or time filter 2230, a two-dimensional region 2240 with an intersection between a bright-dark set of moods and a carefree-sober set of moods, control circuitry 304 may cause the content selection tool shown in display 2200 to include a rating filter 2220 and a demographics filter 2250. Rating filter 2220 may instruct control circuitry 304 to search and/or filter video content by rating (e.g., G, PG, PG-13, R, NC-17, NR, etc.). Demographics filter 2250 may instruct control circuitry 304 to search and/or filter video content by an age group (e.g., toddlers, preschoolers, elementary school kids, etc.).

In particular, FIG. 22 shows an illustrative initial screen of the content selection tool for searching and/or filtering video content. As shown, the user may search for video content by selecting from one or more of: a genre in category and/or subcategory filter 2210, a rating in rating filter 2220, a time period of the video in decades filter 2230 (e.g., the decade during which the video was released), a point or intersections of moods in two-dimensional selection region 2240 (e.g., “bright” and/or “sober”), and/or a demographic category in demographic filter 2250 (e.g., “toddlers”). Additional criteria (not shown) may also be used to limit search results of video content. Using these search and/or filter tools in content selection tool, control circuitry 304 may retrieve movies, television shows, or other video content associated with metadata that match the user-selected criteria for presentation to the user.

It should be noted that two-dimensional selection region 2240 may be substantially similar to the two-dimensional selection region described above. As shown, the mood axes may be bright-dark and sober-carefree, but may also be any other suitable criteria. It should also be noted that, although two-dimensional selection region 2240 and the two-dimensional selection regions described above include two sets of mood axes, the criteria and its corresponding axes may change depending on the other criteria selected by the user (e.g., selected genre criteria), user history data (e.g., recorded programs), user profile data, etc. For example, control circuitry 304 may determine that the user indicated in a user profile or indicated by usage history that the user prefers light, happy music and/or films. Accordingly, control circuitry 304 may configure the two-dimensional selection region may be configured to provide “light” and “happy” axes. Thus, control circuitry 304 may allow the user to control the level of similarity of the media content being searched for to the media the user generally prefers.

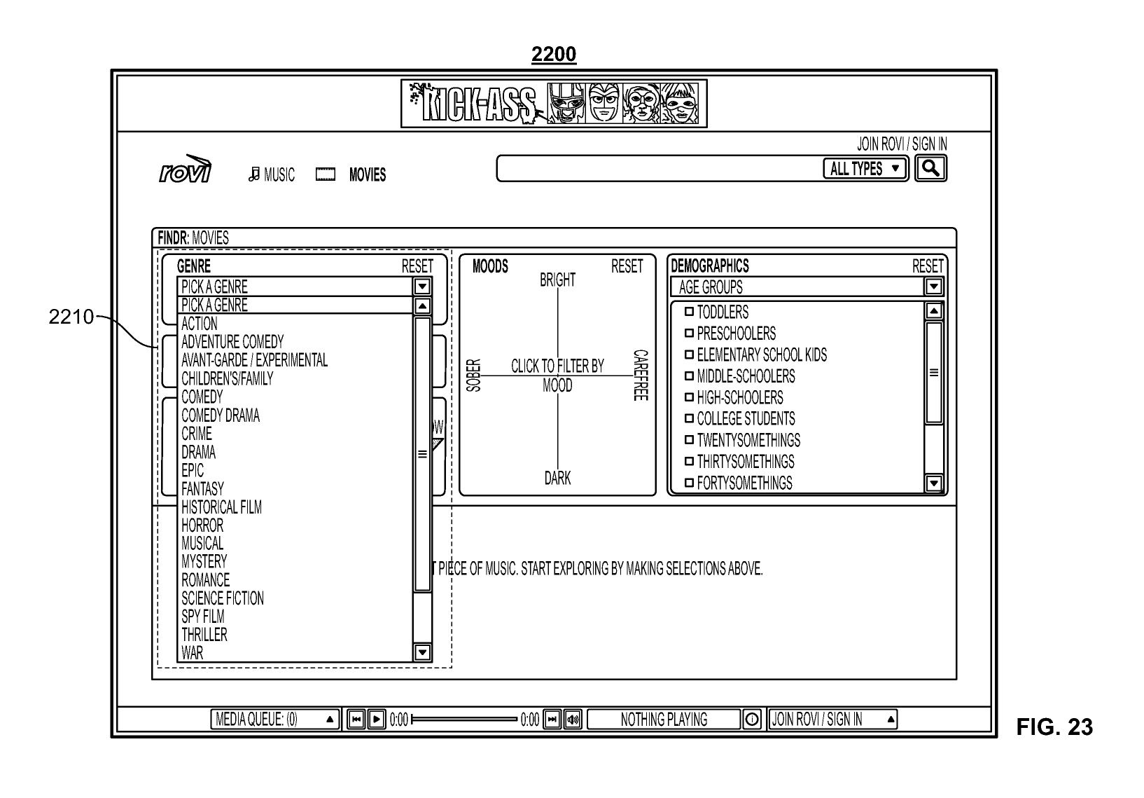

FIG. 23 shows an illustrative example of the various genres that may be selected by the user with category filter 2210. In particular, category filter 2210 in FIG. 23 includes movie genres, such as action, adventure comedy, comedy, crime, drama, etc. In response to receiving a user-selected genre (e.g., action) to search and/or filter video content, control circuitry 304 performs a search through video content for metadata matching the user-selected genre and a plurality of media identifiers are displayed in search results region 2260. Each of the media identifiers, which are displayed as thumbnails containing movie art in search results region 2260, corresponds to media content (e.g., a movie, a television program, video clips, games, etc.).

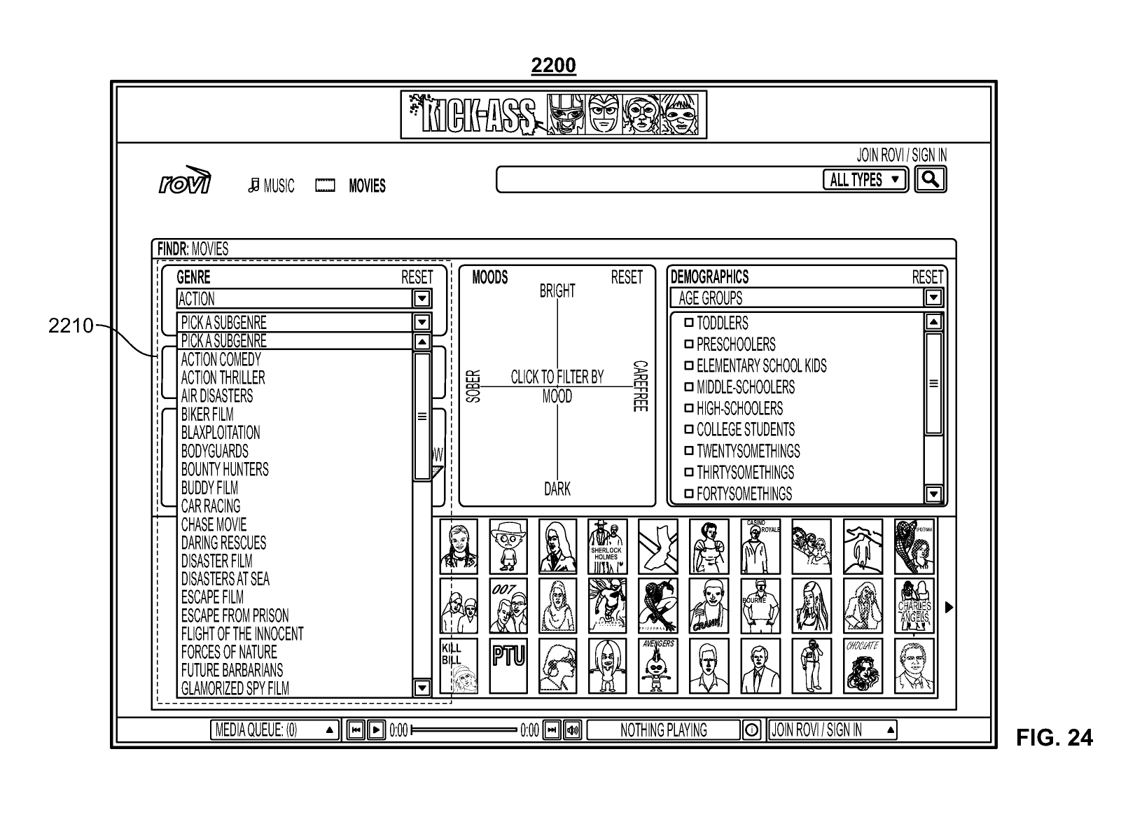

Turning to FIG. 24, control circuitry 304 has activated a subcategory or subgenre filter in response to receiving a user selection for the category or genre filter shown in FIG. 23. In particular, in response to receiving a user selection for the category filter in region 2210, control circuitry 304 may transmit a query to a database for subcategory information associated with the selected category. Upon receiving the subcategory information, control circuitry 304 may populate a drop-down list in region 2210 for selection by the user. For example, as shown in FIG. 24, in response to the user selecting “action” in the category filter of FIG. 23, control circuitry 304 may provide the user with a drop-down list in region 2210 of corresponding subcategories. The subcategories or subgenres associated with the action music category may include, for example, action comedy, action thriller, bounty hunters, car racing, etc.

In response to receiving a subcategory or subgenre from the user in region 2210, control circuitry 304 may refine the content provided in search results region 2260. For example, control circuitry 304 may search through the metadata associated with the media content in search results region 260 to find media content that matches the updated criteria.

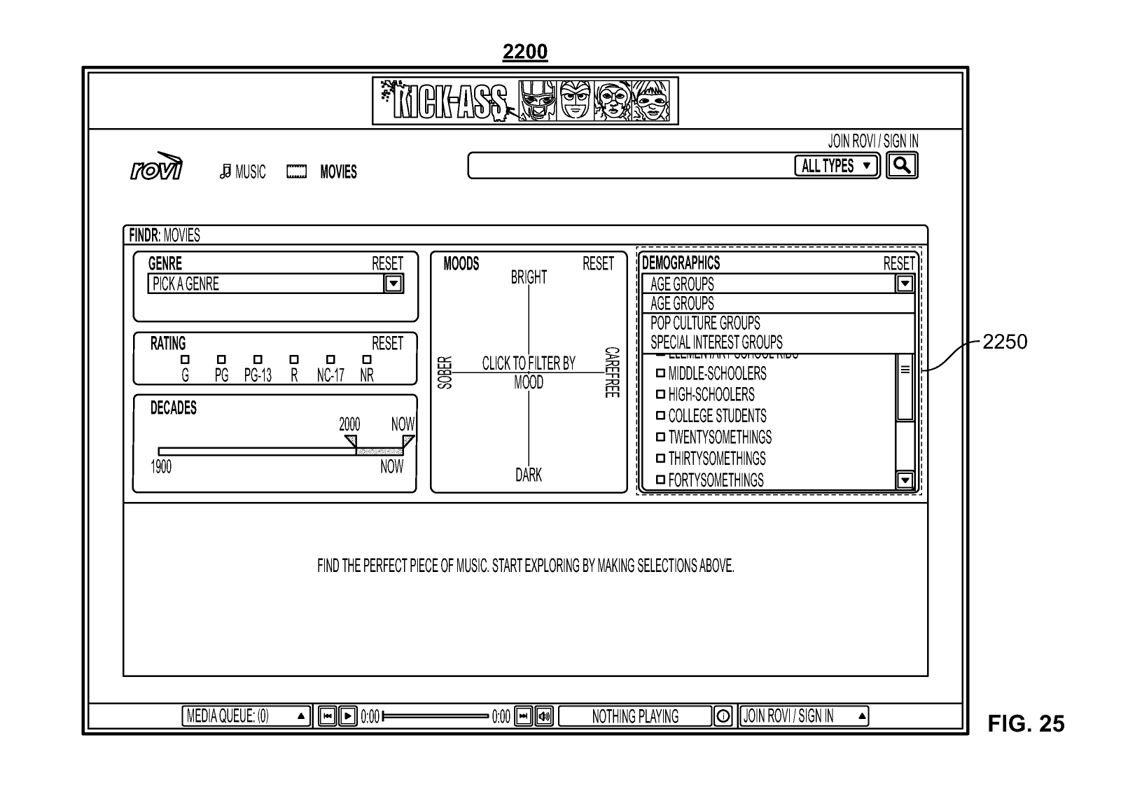

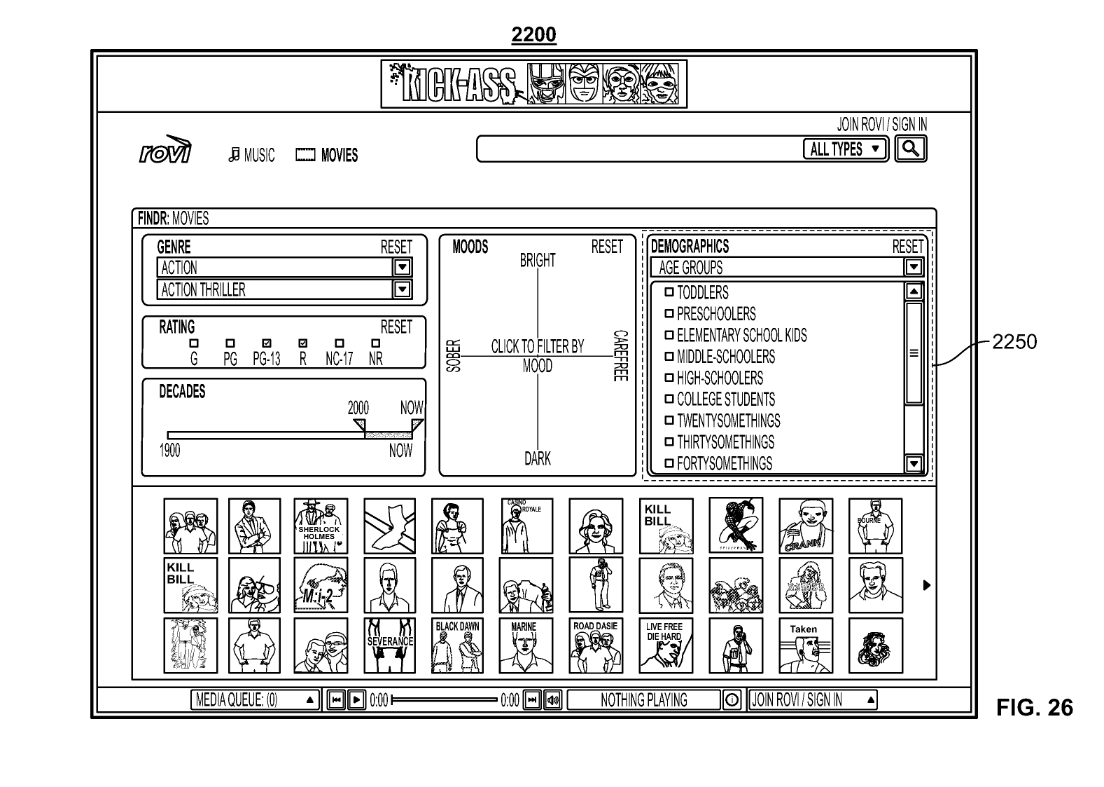

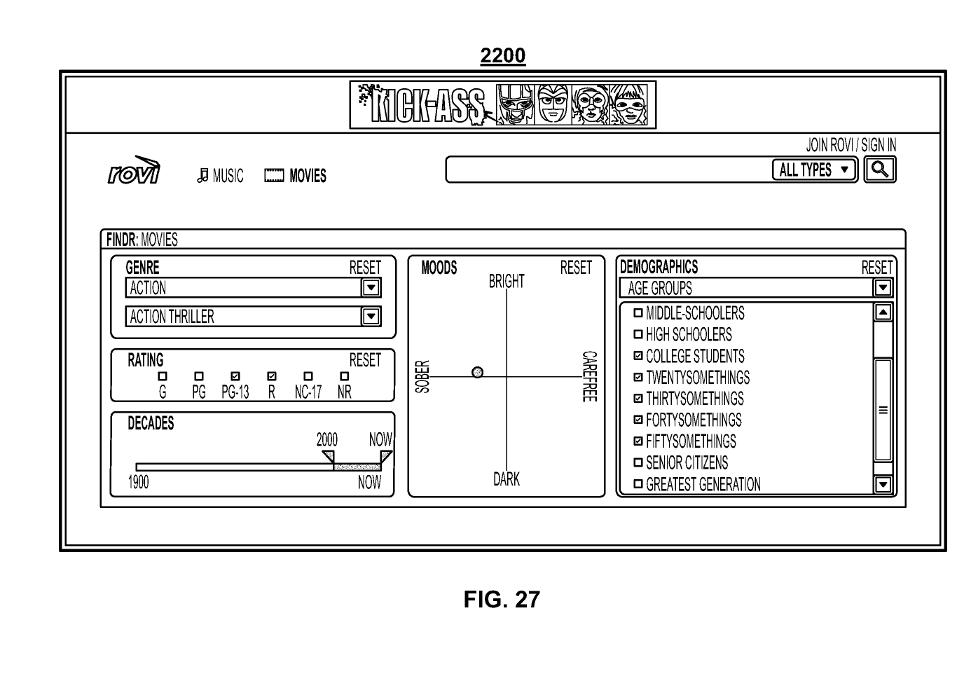

As shown in FIG. 25, the user may select a demographic group that instructs control circuitry 304 to filter the media content provided in search results region 2260. A demographic group may be any suitable age group, pop culture group, or special interest group. In response to receiving a user selection for demographic filter 2250, control circuitry 304 may transmit a query to a database for subcategory information associated with the selected demographic group. Upon receiving the subcategory information, control circuitry 304 may populate a drop-down list in region 2250 for selection by the user. For example, as shown in FIG. 25, in response to the user selecting the demographic group “age groups” in demographic filter 2250 of FIG. 25, control circuitry 304 may provide the user with a drop-down list in region 830 of corresponding subcategories as shown in FIG. 26. The subcategories or subgenres associated with the “age group” demographic group may include, for example, toddlers, preschoolers, elementary school kids, middle-schoolers, high-schoolers, college students, etc. As shown in FIG. 27, the user has selected the subcategories “college students,” “twentysomethings,” “thirtysomethings,” “fortysomethings,” and “fiftysomethings.”

As also shown in FIG. 27, the user has selected the genre “action” and the subgenre “action thriller” in the category and/or subcategory filter, the ratings “PG-13” and “R” in the rating filter, the time period between 2000 and now in the decades filter, a point in the two-dimensional selection region that is more sober than carefree and slightly brighter than darker in mood, and subcategories “college students,” “twentysomethings,” “thirtysomethings,” “fortysomethings,” and “fiftysomethings” in the demographics filter. Control circuitry 304 may use the user-selected criteria in combination to filter the video content provided in a search results region. As described above, video content may be associated with criteria through metadata (e.g., metadata descriptors).

In response to entering and/or selecting from various criteria, control circuitry 304 may performs a search through content for metadata matching the user-selected criteria and a plurality of selectable media identifiers are displayed in search results region 2260. For example, in response to navigating to a particular media identifier (e.g., a selectable media identifier of “The Pianist”) from the plurality of selectable media identifiers in search results region 2260, control circuitry 304 may provide the user with text information associated with the media asset, such as the movie title (e.g., “The Pianist”).

In some embodiments, control circuitry 304 may monitor the navigation by the user. For example, when control circuitry 304 determines that the cursor is placed over the selectable media identifier, control circuitry 304 may highlight or activate selectable media identifier (e.g., increase the brightness of the thumbnail image) and provide the user with text information associated with the media asset (e.g., the movie title).

In some embodiments, control circuitry 304 may monitor the location with respect to a selectable media identifier. For example, control circuitry 304 may detect whether the location coordinates of a cursor are approaching the center of a selectable media identifier. In a more particular example, in response to determining that the cursor has been placed near the center of a selectable media identifier, control circuitry 304 may activate a playback option. Playback option may, for example, instruct control circuitry 304 to retrieve and/or play a video clip, a movie trailer, the actual video content associated with the media identifier, or any other suitable video content. In some embodiments, selecting a media identifier (e.g., video cover art) instructs control circuitry 304 to load a trailer or other relevant video clip, or the video content itself into a video queue, which may be accessed at any time to play the added video content.

In some embodiments, control circuitry 304 may provide supplemental media content. For example, selecting a selectable media identifier may instruct control circuitry 304 to load a video list with all available clips associated with the video content. In another example, if the video content is associated with a music album or one or more songs, selecting the video thumbnail may instruct control circuitry 304 to load sample audio clips into a media queue (e.g., media queue 1700 of FIG. 17). In this example, a user may also select a thumbnail to retrieve the album (or songs) or to access additional information relating to the album (or songs).

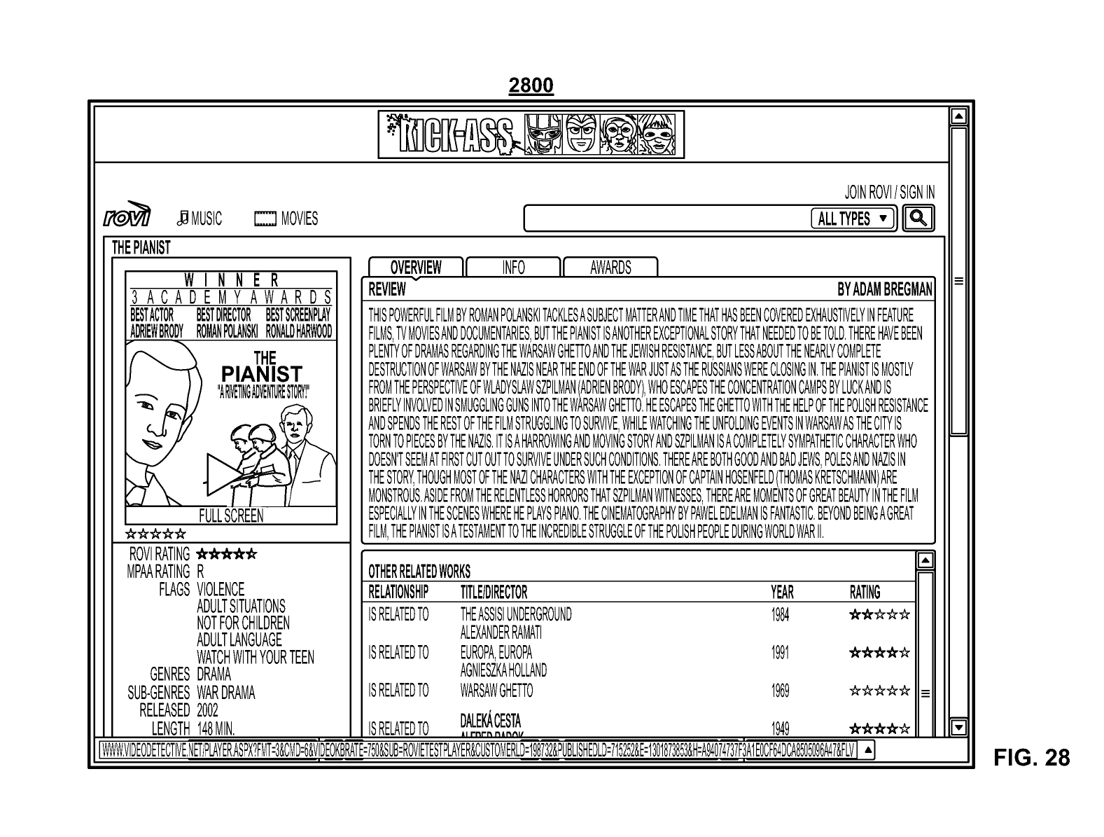

In some embodiments, in response to selecting a selectable media identifier for video content, control circuitry 304 may provide the user with access to additional information and other media content associated with a particular movie or other video content. For example, as shown in an illustrative media information display 2800 of FIGS. 28-39, in response to the user receiving a plurality of media identifiers after using content selection tool 640 and selecting a selectable media identifier corresponding to the movie “The Pianist,” control circuitry 304 may provide the user with access to information and other media content associated with the movie content.

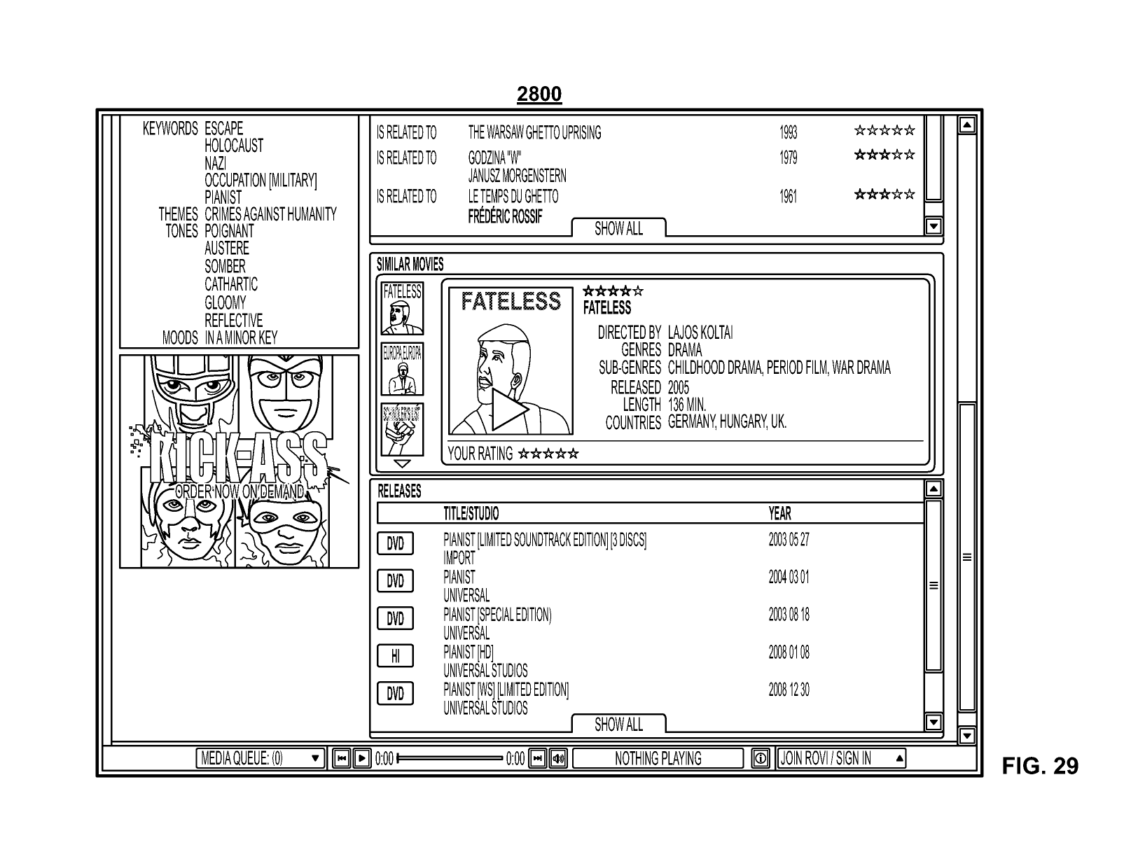

Media information display 2800 may include reviews of the movie, rating information, award information, and other pertinent information. In some embodiments, control circuitry 304 may retrieve metadata associated with the selected video content and present portions of the metadata in media information display 2800. For example, as shown in FIGS. 28 and 29, media information display 2800 includes the keywords (e.g., escape, Holocaust, occupation [military], and pianist), themes (e.g., crimes against humanity), and tones (e.g., poignant, austere, somber, cathartic, gloomy, and reflective) associated with the video content.

It should be noted that control circuitry 304 may retrieve metadata associated with the selected media content for presentation in display 2800. In some embodiments, control circuitry 304 may transmit a query to other sources (e.g., media guidance data source 418, a social networking website, a movie review website, etc.) to assemble the metadata for presentation in display 2800.

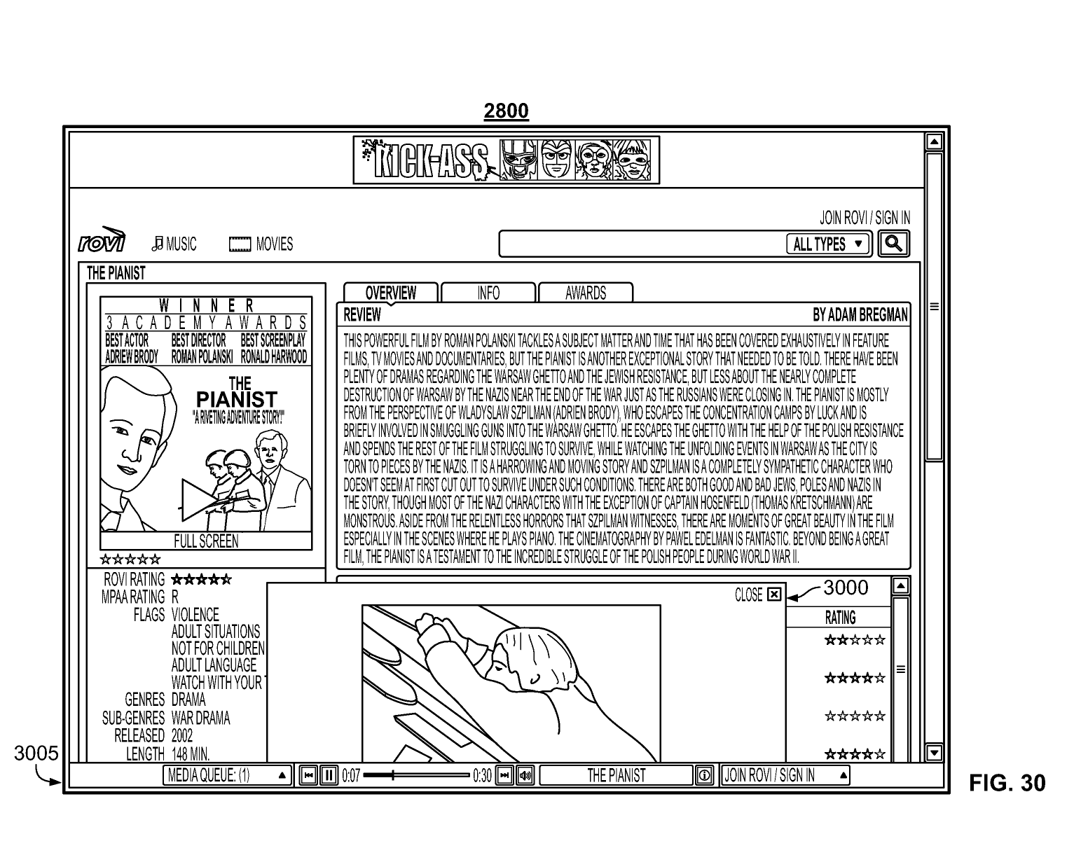

FIG. 30 shows an illustrative display screen of a media guidance application with an overlay 3000 containing a trailer or other video clip related to a particular movie or other video content (e.g., selected from the display screen of FIGS. 28 and 29) in accordance with some embodiments of the invention. In particular, overlay 3000 may display a trailer or other video clip when the video cover art or other media identifier is selected. In some embodiments, the video clip played in overlay 3000 may be placed in a media queue 3005. Media queue 3005 may include media control options for controlling the playback of the video clip in overlay 3000. The video clip may be hidden and/or revealed as desired by the user. Overlay 3000 and media queue 3005 may also persist as the user browses through other display screens in the media guidance application, thereby providing the user with access to other display screens while the video clip continues to play.

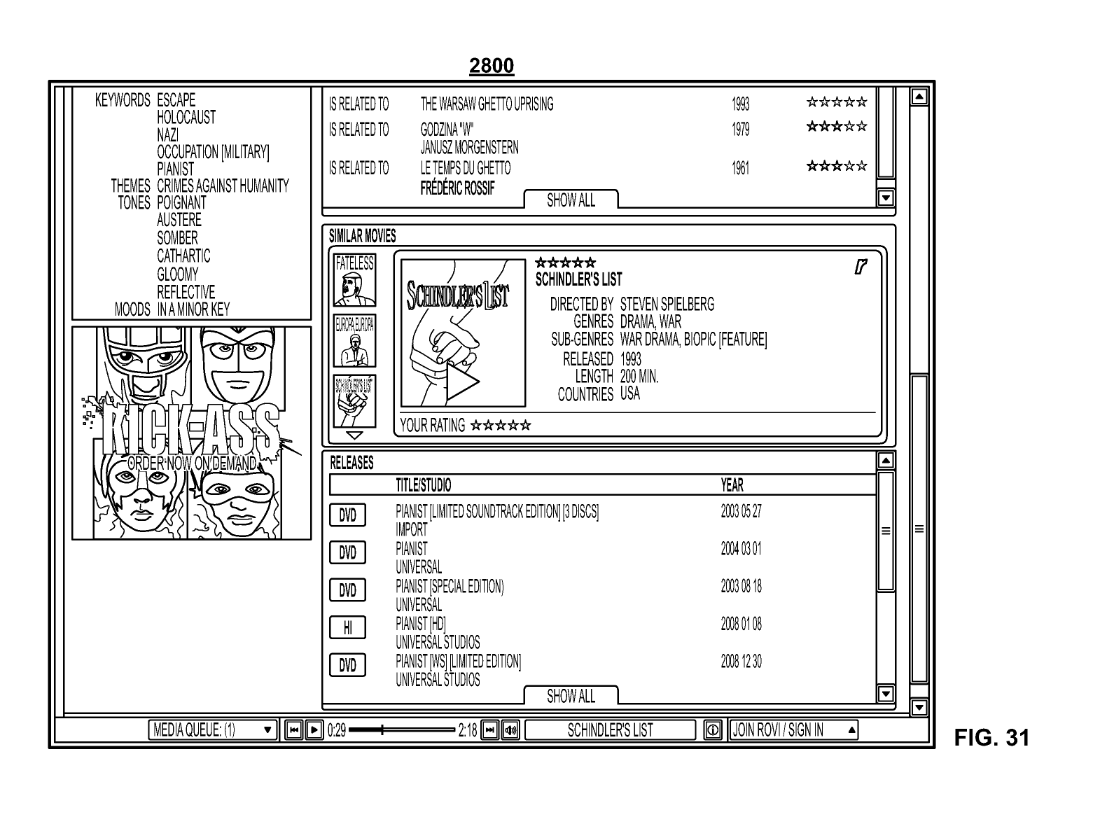

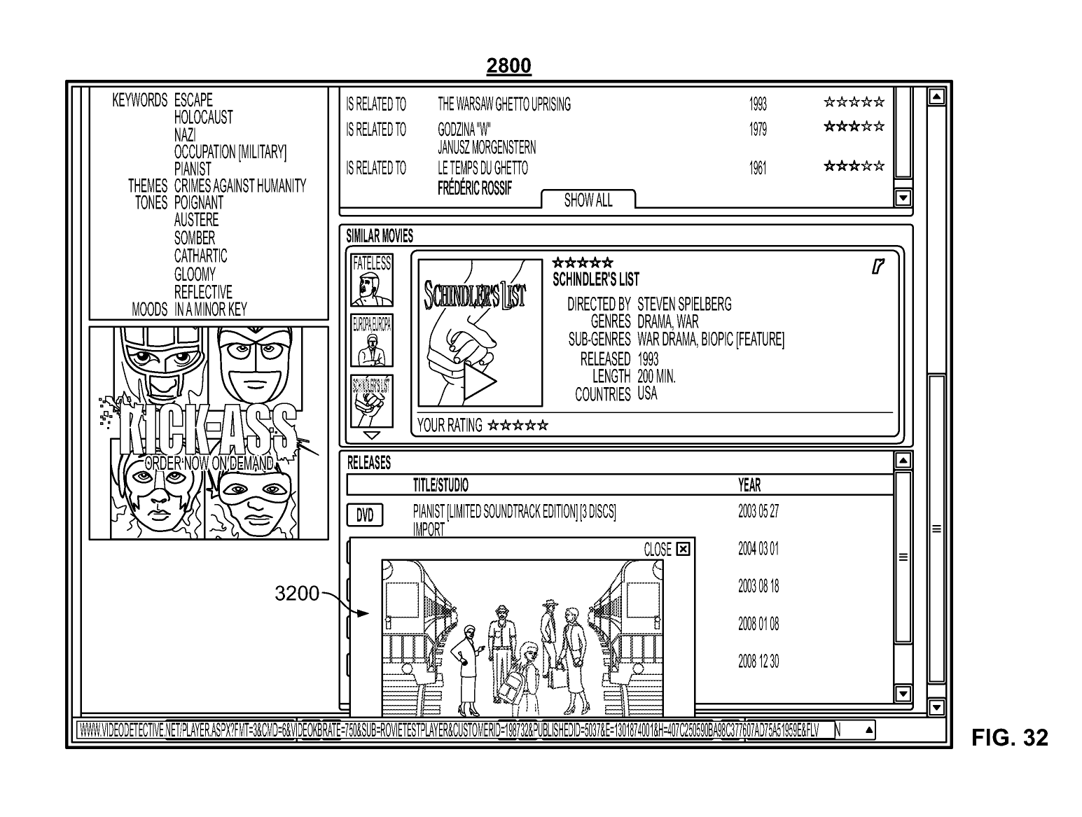

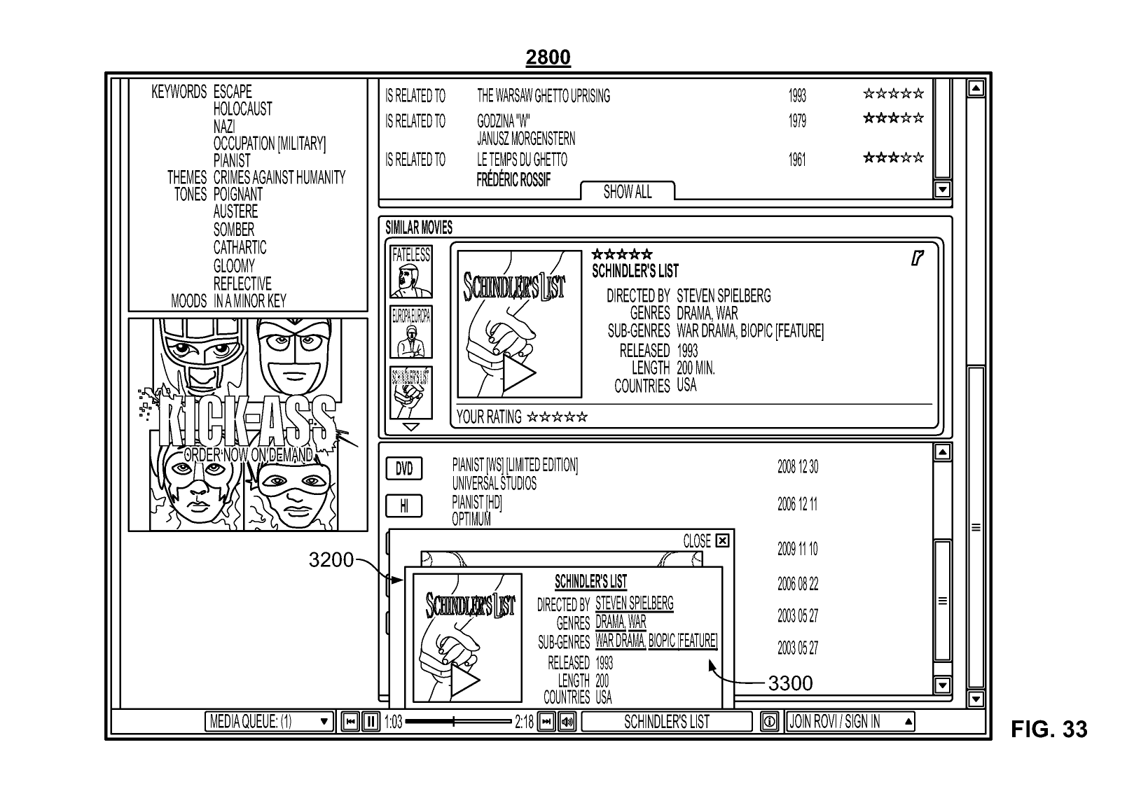

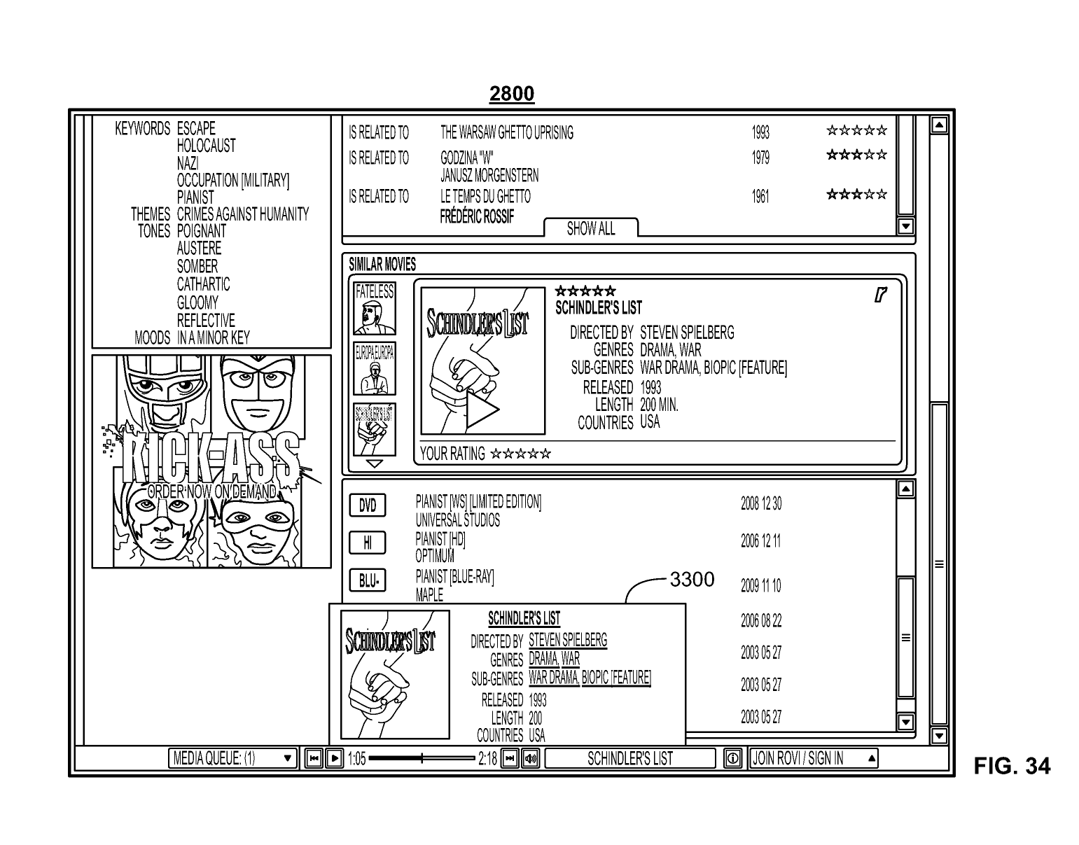

FIGS. 31-34 show an illustrative display screen of a media guidance application that may be used to access information and/or a media clips related to media content associated with a particular movie (or other video content) in accordance with some embodiments of the invention. As shown in FIG. 31, video content (e.g., a trailer for the movie “Schindler's List”) related to the media content of the display screen (e.g., the movie “The Pianist”) may be accessed directly for playing or adding to the media queue. As shown in FIG. 32, control circuitry 304 may display the related video content within an overlay 3200, and may allow the user to control the playback of the related video content with the media control options provided by the media queue. As shown in FIG. 33, control circuitry 304 may retrieve information relating to the video clip being played and display the information in the overlay in second overlay 3300, which is placed over the video clip. Both overlays 3200 and 3300 may be hidden or revealed as desired, and the video clip may continue to play while the second overlay with information is displayed. For example, as shown in FIG. 34, the video clip in overlay 3200 may be hidden while the information overlay 3300 remains displayed.

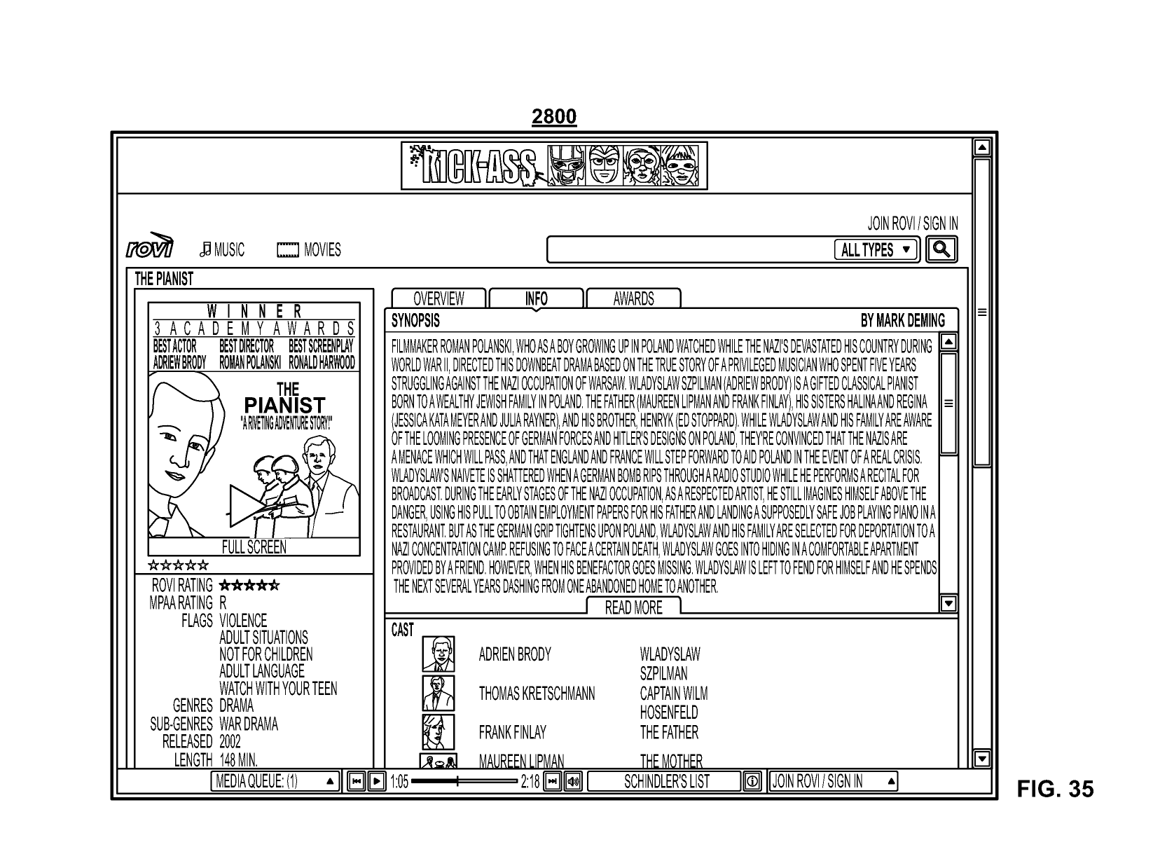

FIG. 35 shows an illustrative display screen of a media guidance application that may be used to access additional information associated with a particular movie or other media content in accordance with some embodiments of the invention. As shown, display screen 2800 may include a synopsis of the movie content and cast information. As also shown, control circuitry 304 may allow the user to select a cast member or other supplemental content from display screen 2800 to retrieve information related to that cast member.

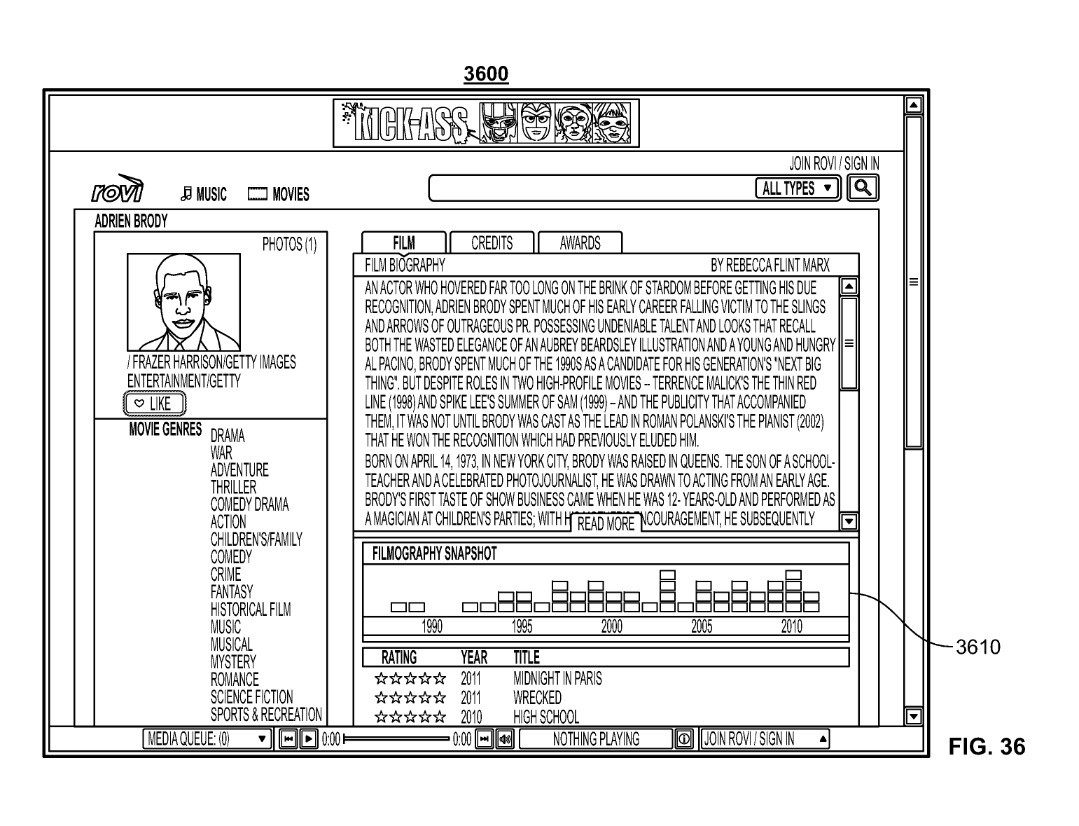

FIGS. 36-39 show an illustrative display screen 3600 of a media guidance application that may be used to access information and/or media content associated with a person (e.g., an actor, artist, or performer) in accordance with some embodiments of the invention. For example, as shown in FIG. 36, control circuitry 304 may cause a filmography snapshot portion 3610 to be displayed in display screen 3600. Filmography snapshot portion 3610 may indicate the number of movies, television shows, and/or other appearances made by an actor each year. In the case of a musical artist, a corresponding discography snapshot may be displayed indicating the number of albums released per year. In cases where a single artist both acts and musically performs, a combined display may indicate the number of releases featuring the artist—whether a movie, television show, or album—in each year. As shown, each release (e.g., movie and/or album) may be indicated by a block. However, it should be noted that any other suitable indicator of any size, shape, and color may also be used.

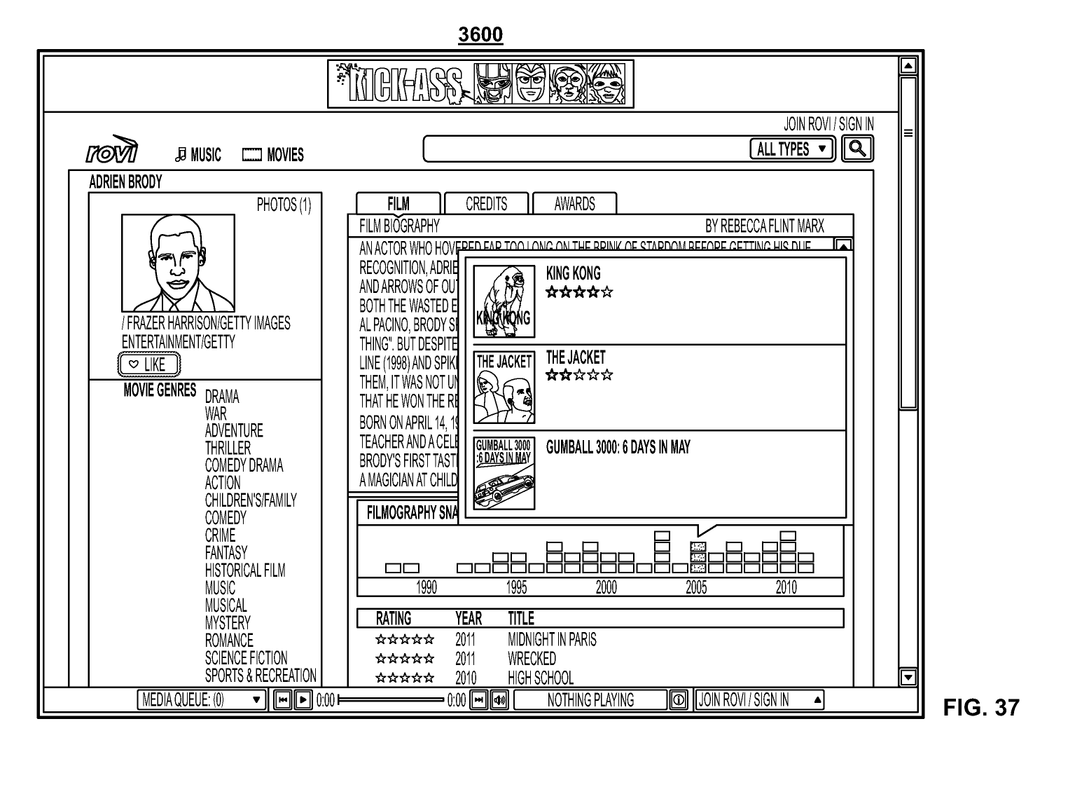

Turning to FIG. 37, when the user scrolls over, or otherwise selects, a column of boxes (e.g., corresponding to the releases in a particular year) in filmography snapshot portion 3610, control circuitry 304 may cause an overlay 3700 to be displayed with a list of the releases. Thus, the media guidance application may allow a user to quickly browse through the years to view an artist's work and access a particular work by selecting it from the list displayed in the overlay.

In some embodiments, control circuitry 304 may allow the user to add the contents of a list to the video and/or music queue for later review.

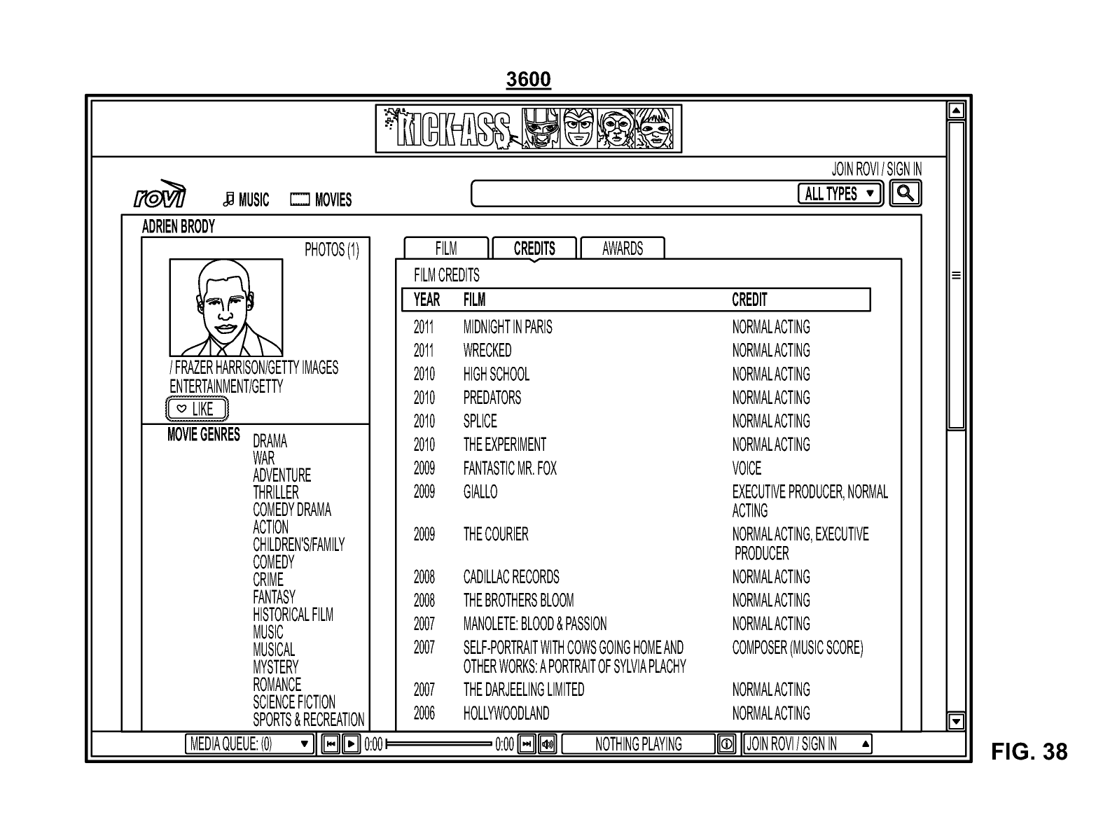

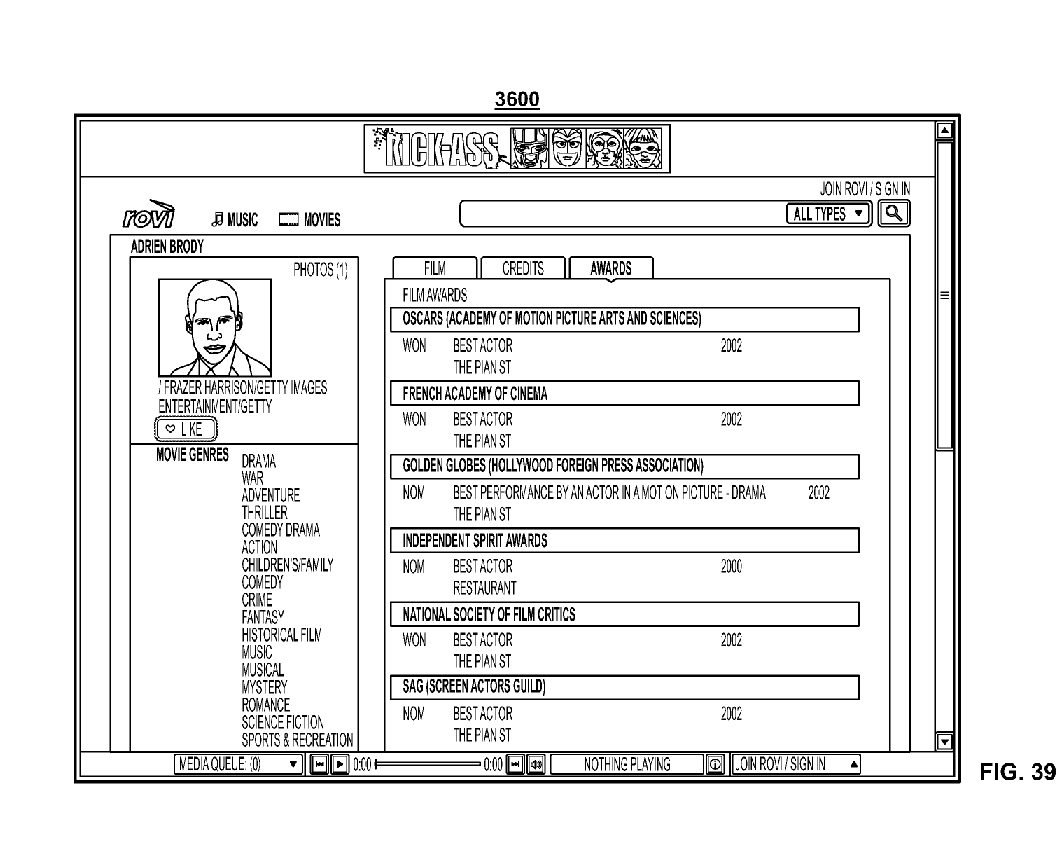

Any other suitable information relating to the selected artist may be provided in media guidance display 3600. For example, FIG. 38 shows that media guidance display 3600 may include credit information relating to the selected artist. In another example, FIG. 39 shows that media guidance display 3600 may include award information relating to the selected artist. As discussed above, data displayed may be cross-referenced and linked such that any reference to media content allows quick and easy access to that media content or a related media clip. For example, the user may select a movie for which an actor received an award to access a trailer of that movie.

As described above, the media information display described herein may also be displayed in response to, for example, selecting an album from trending media content section of third region 630 in FIG. 6, or inputting the album name or other identifying information into general searching tool 612 in first region 610 in FIG. 6.

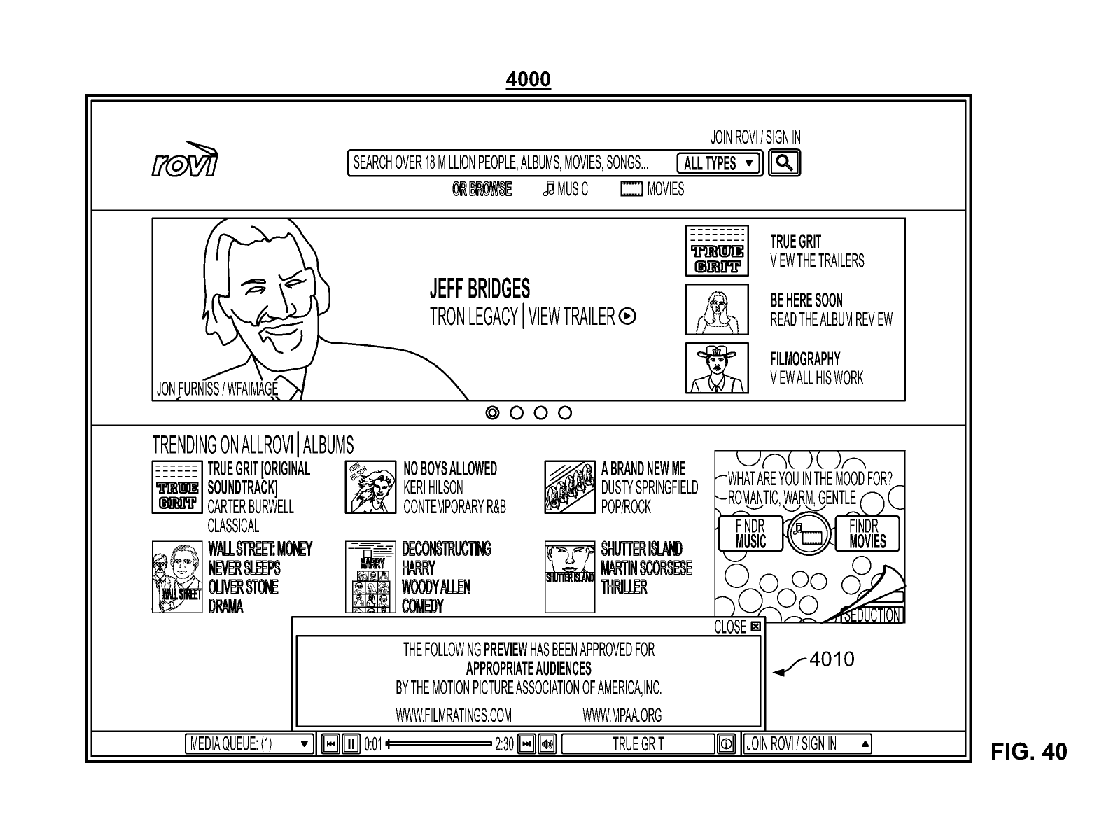

FIGS. 40-42 show illustrative display screens of a media guidance application depicting a variety of techniques for accessing music and/or video clips, or other information related to media content displayed in a cycling advertorial in accordance with some embodiments of the invention. When a user selects to view a trailer from an advertorial in guidance display 4000, for example, control circuitry 304 may display the trailer in an overlay 4010 without leaving the display screen. FIG. 40, for example, shows overlay 4000 containing a trailer for the movie “True Grit” that relates to the actor “Jeff Bridge” promoted in an advertorial. Control circuitry 304 may allow the user to play the trailer or close overlay 4010 as the advertorial continues to cycle to the next advertorial.

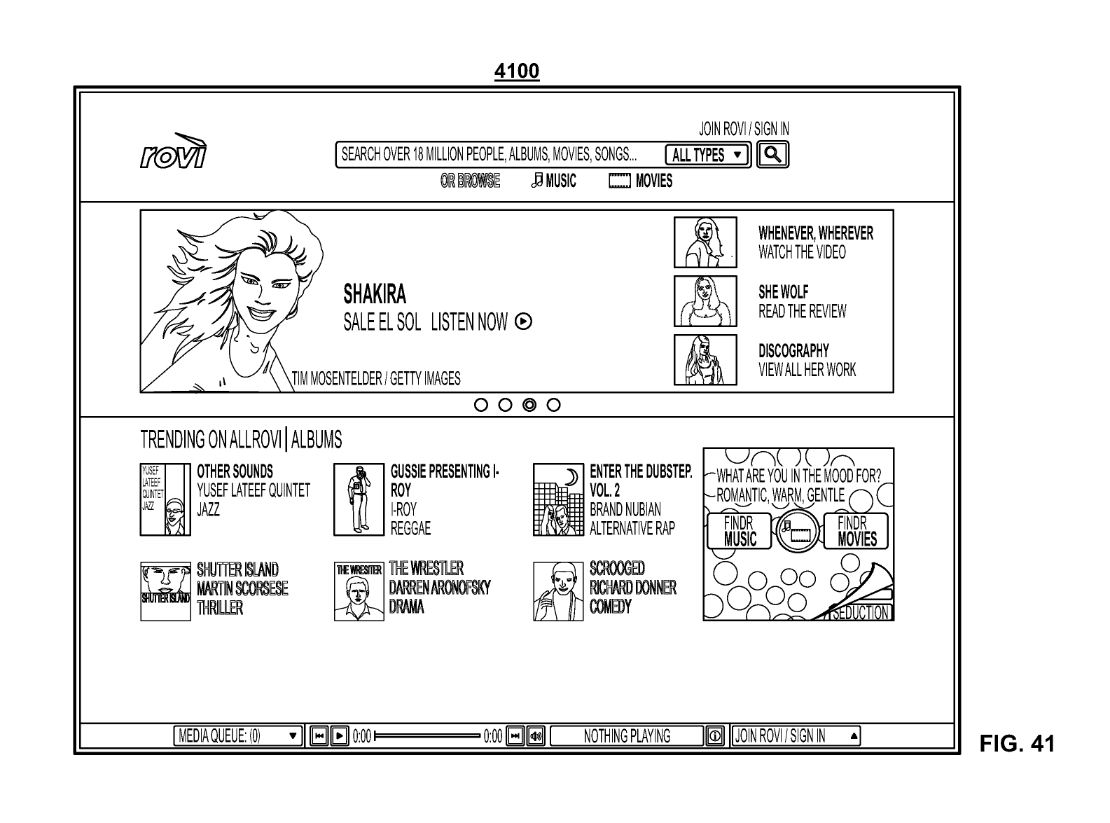

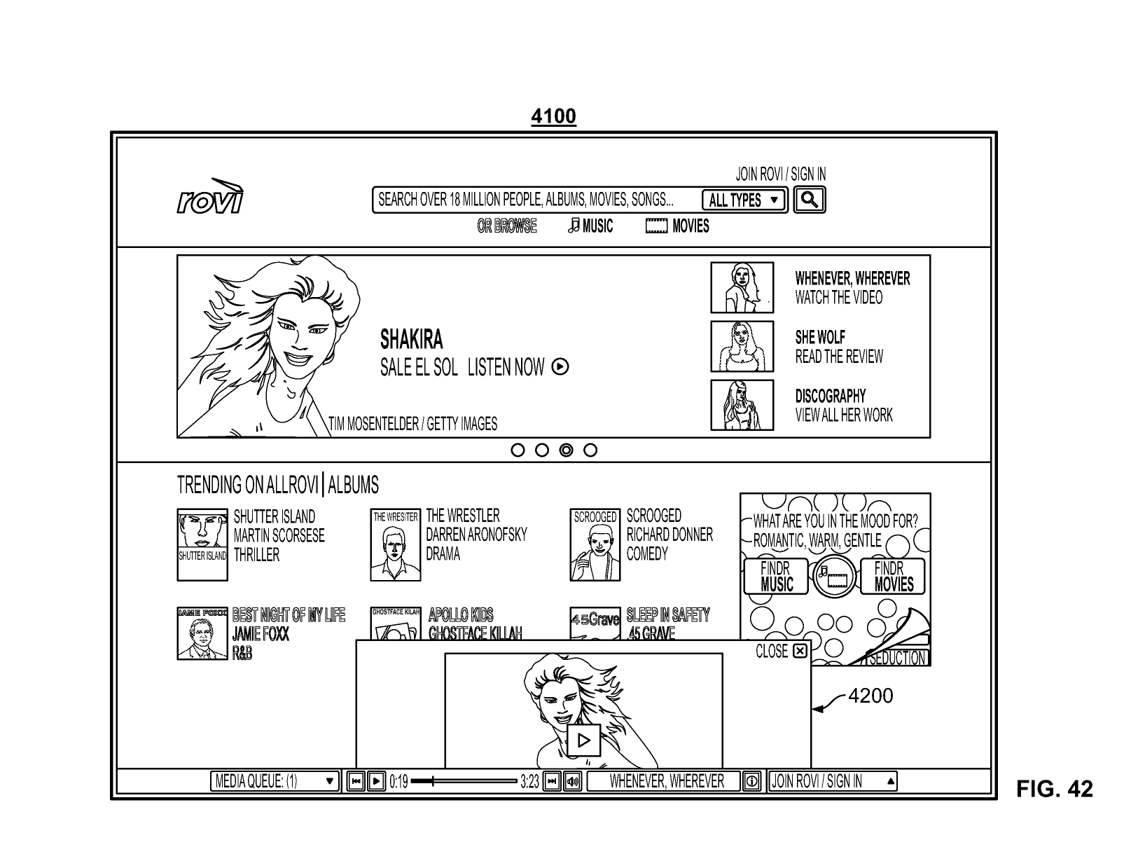

As described above, overlays and/or media queue may be persistent throughout the guidance displays presented by the media guidance application. For example, FIG. 41 shows an illustrative display screen with an advertorial featuring the music artist “Shakira.” The advertorial may feature the music artist and their related works. For example, guidance display 4100 may provide the user with access to music content, video content, access to associated information, or any other suitable media content related to the music artist. In a more particular example, the user has selected to watch a music video for the song “Whenever, Wherever” by Shakira. As shown in FIG. 42, control circuitry 304 may display the video clip in an overlay 4200. In addition, control circuitry 304 may place the video content in a media queue, which provides media control options for controlling the playback of the video content. The user may then select to view a review of the album “She Wolf.” As shown in FIG. 43, control circuitry 304 causes the video clip in overlay 4200 to continue to play even as the user browses to another display screen using the media guidance application. The user may navigate back or to other information through various other display screens in the media guidance application, yet the overlay persists until the user closes it or the video content finishes playing.

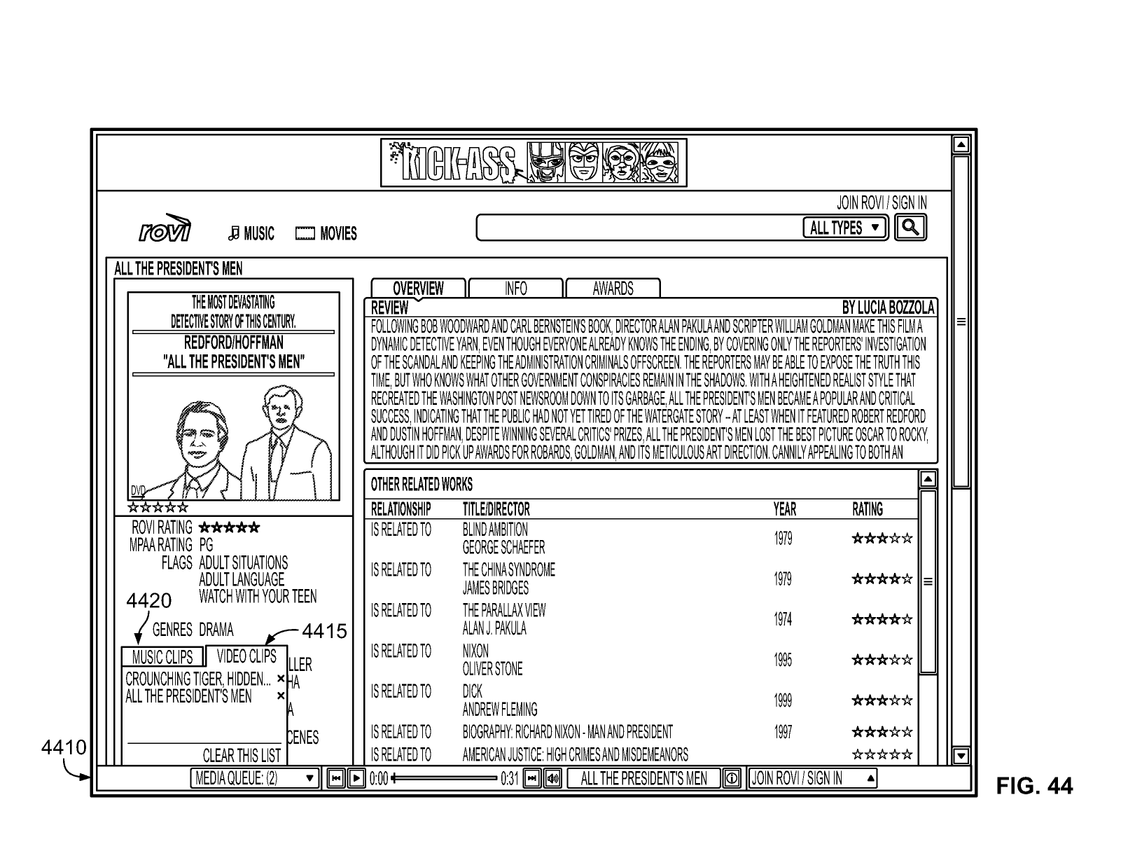

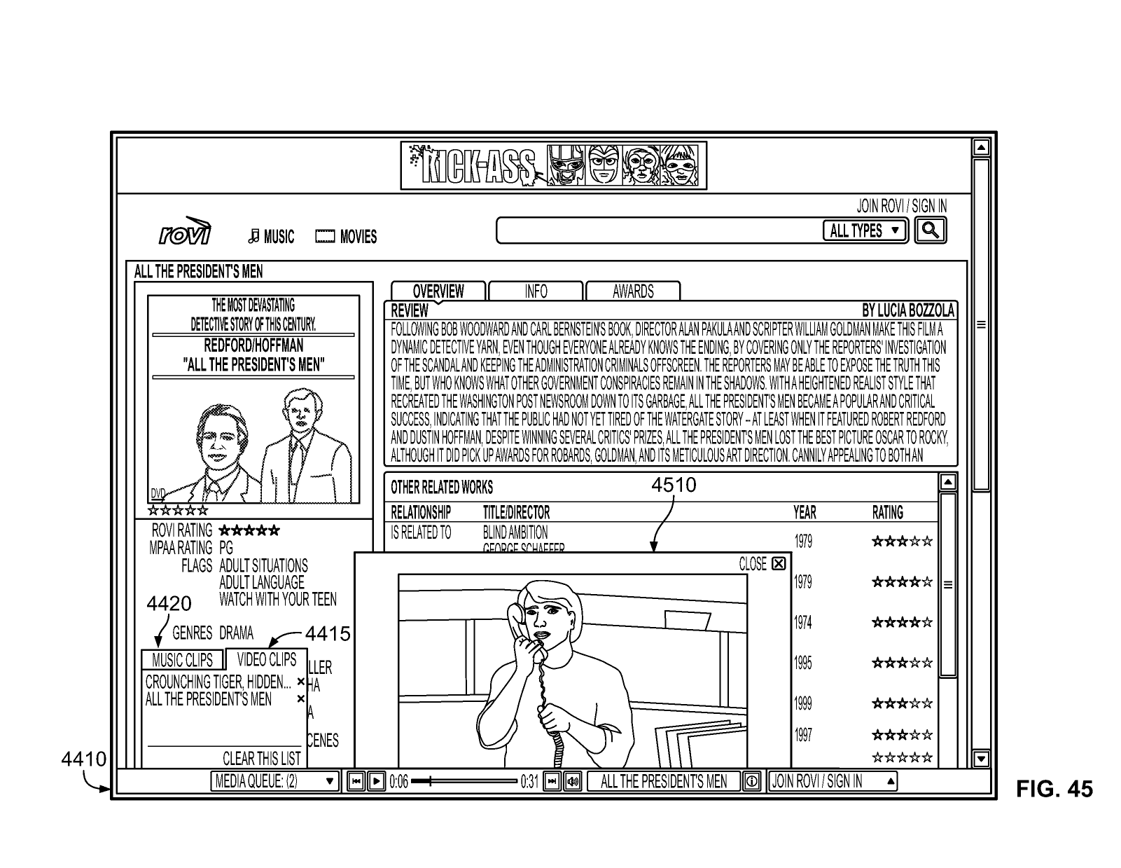

FIGS. 44-47 show illustrative display screens of a media guidance application depicting a media queue for managing one or more lists of music, video clips, or any other suitable content in accordance with some embodiments of the invention. When a video clip is selected by the user, control circuitry 304 may add the video clip to the media queue 4410 as shown in FIG. 44. Media queue 4410 may be displayed by selecting the “Media Queue” display element at the bottom of display screen 4400. In some embodiments, the media queue may be an overlay displayed over the content of display screen 4400. In addition, media queue 4410 may be divided into at least two panels 4415 and 4420—e.g., one for video clips (panel 4415) and one for music clips (panel 4420). Alternatively, media queue 4410 may include an aggregate list of any media content selected by the user. From within media queue 4410, a user may select a clip to play in an overlay, such as an overlay 4510 shown in FIG. 45. Media queue 4410 may also allow that user to delete an item from within the queue.

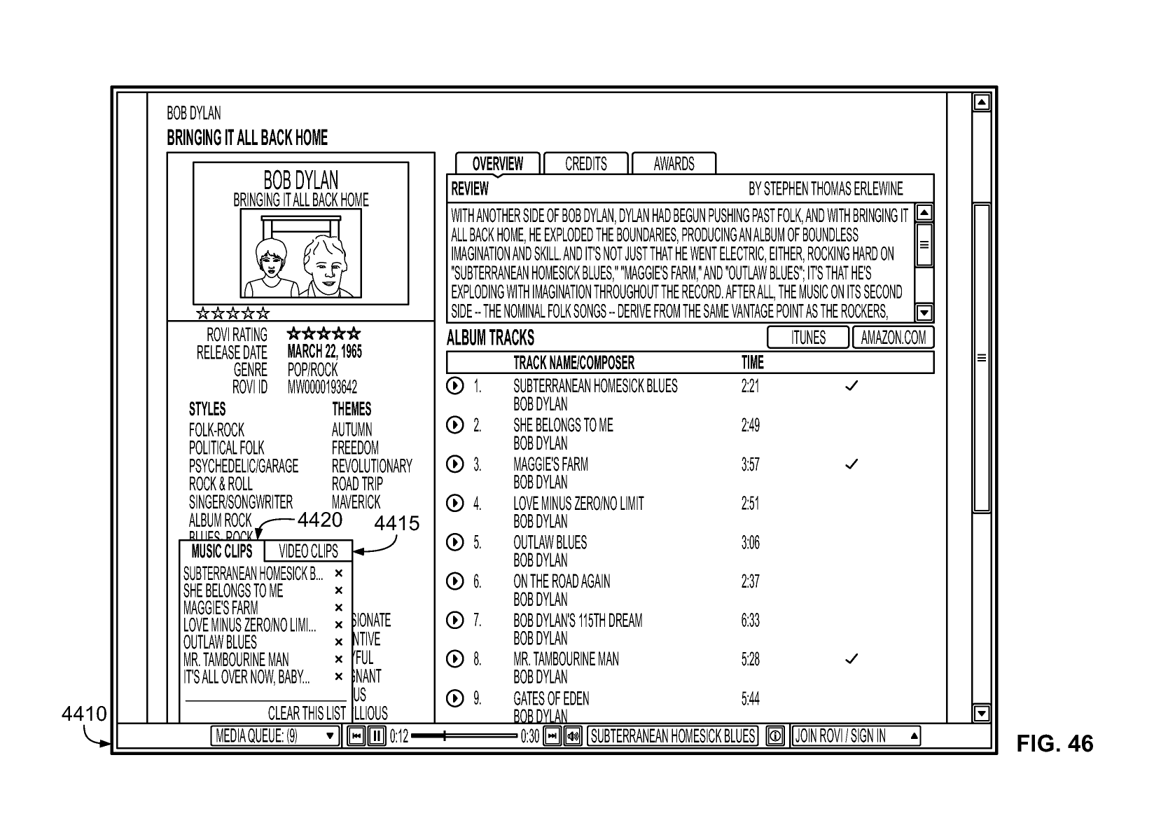

As shown in FIG. 46, media queue 4410 may also include music clips in panel 4420. The list may be populated by selecting clips from one or more display screens. In particular, control circuitry 304 may store user selections that are placed in media queue 4410 in memory. Music clips, like video clips, may be played and deleted. In some embodiments, media queue 4410 or any other portion of the media guidance application may provide the user with the opportunity to purchase one or more media clips, e.g., directly through media queue 4410.

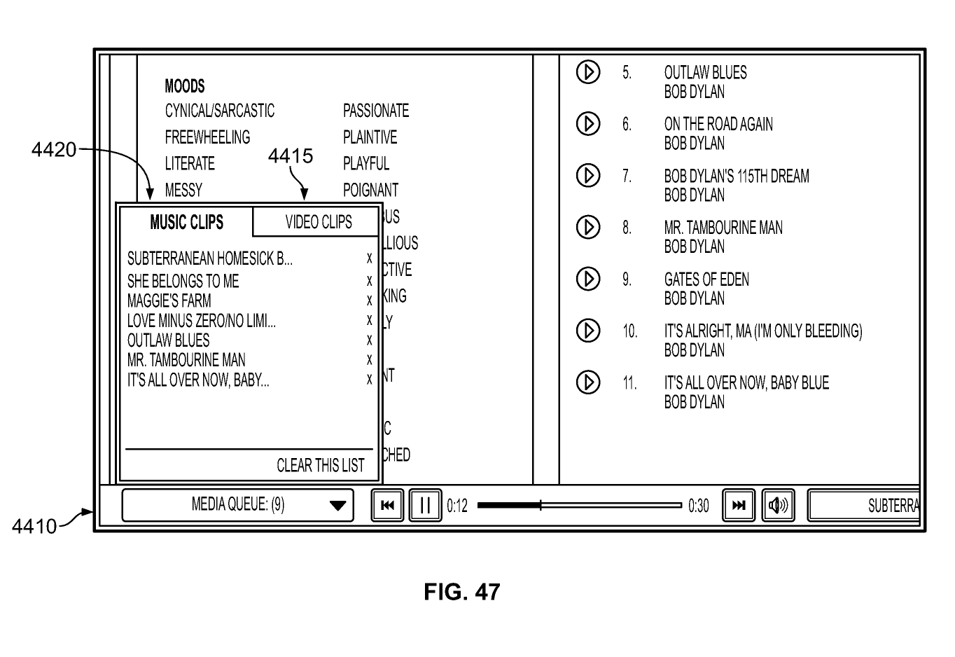

In some embodiments, the media guidance application may provide the user with a user-configurable media queue. FIG. 47 provides an enlarged view of the media queue in accordance with some embodiments of the invention. As shown, clips may be played in any order and the user may rearrange the order of the items listed. In some embodiments, the media queue automatically plays through the listed content, moving from one item to the next in the queue until all clips have been played.

In some embodiments, referring back to FIG. 6, control circuitry 304 may provide the user with access to information directly from general searching tool 612. For example, when a person's name is entered into the general searching tool 612, a biography of that person may appear in an overlay over the current display screen. As another example, a user may enter a song name into general searching tool 612 or any other suitable mechanism and may be able to play the song without navigating away from the current display screen. Thus, the user elements described herein may function to enable a user to find and access media information, but also, simultaneously, as media control elements allowing the user to play media clips as the user browses for entertainment information. Accordingly, a mixed-media, immersive experience is provided.

Furthermore, it should be noted that the media guidance application may provide the user with information in a mixed-media context. For example, as described above, an advertorial may highlight an artist's work in film, television, and/or music. Similarly, biographies and other information on individuals may highlight that individual's contribution to film, television, and/or music. Clips from each of these media types may be integrated and made available to the user. In addition, these clips may be accessed through the media queue, which is itself a mixed-media tool capable of handling both music and video assets.

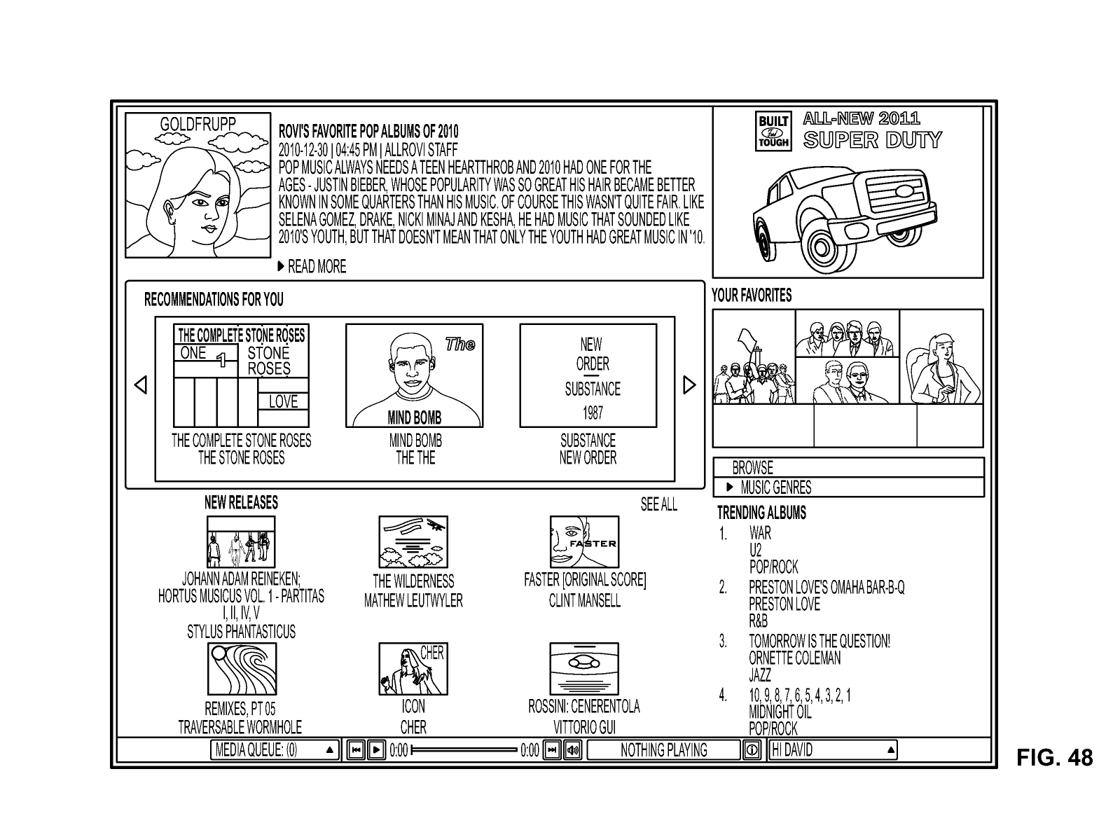

FIG. 48 shows an illustrative display screen of a media guidance application depicting a recommendation feature in accordance with some embodiments of the invention. In particular, the user may set up a profile in which indications of the user's preferred media content is stored. As the user indicates likes and dislikes, and, as the site learns more about the user, e.g., by tracking user actions and viewing history, control circuitry 304 may provide recommendations of media determined to be of interest to the user. Additionally or alternatively, control circuitry 304 may retrieve user profile information and user history information from user television equipment 502, user computer equipment 504, and/or wireless communications devices 506 for providing recommendations of media content.

In a more particular example, the media guidance application may provide the user with the opportunity to indicate whether the user likes a particular artist. In another example, the media guidance application may provide the user with the opportunity to rate media content. As the user continues to indicate preferences and/or uses the media guidance application, the user profile may continue to be updated and used as a basis for providing recommendations.

As shown in FIG. 48, control circuitry 304 may cause recommended media content to be presented to the user based on, for example, the user profile. In addition, new releases of media content may be recommended to the user based on the user profile. For example, a new album by an artist the user has indicated a strong liking for may be displayed prominently. In addition, as shown in FIG. 48, the display screen may display, pictorially, the media content or artists a user has indicated as favorites. Thus, a visual mash-up may be created with thumbnails or pictures of various media content and artists the user likes. Thus, the user is provided with a visual representation of the user profile, and may edit it accordingly. It should be noted that, in some embodiments, active user selections or indications of likes and dislikes may be weighted more heavily than tracked user history when providing recommendations.

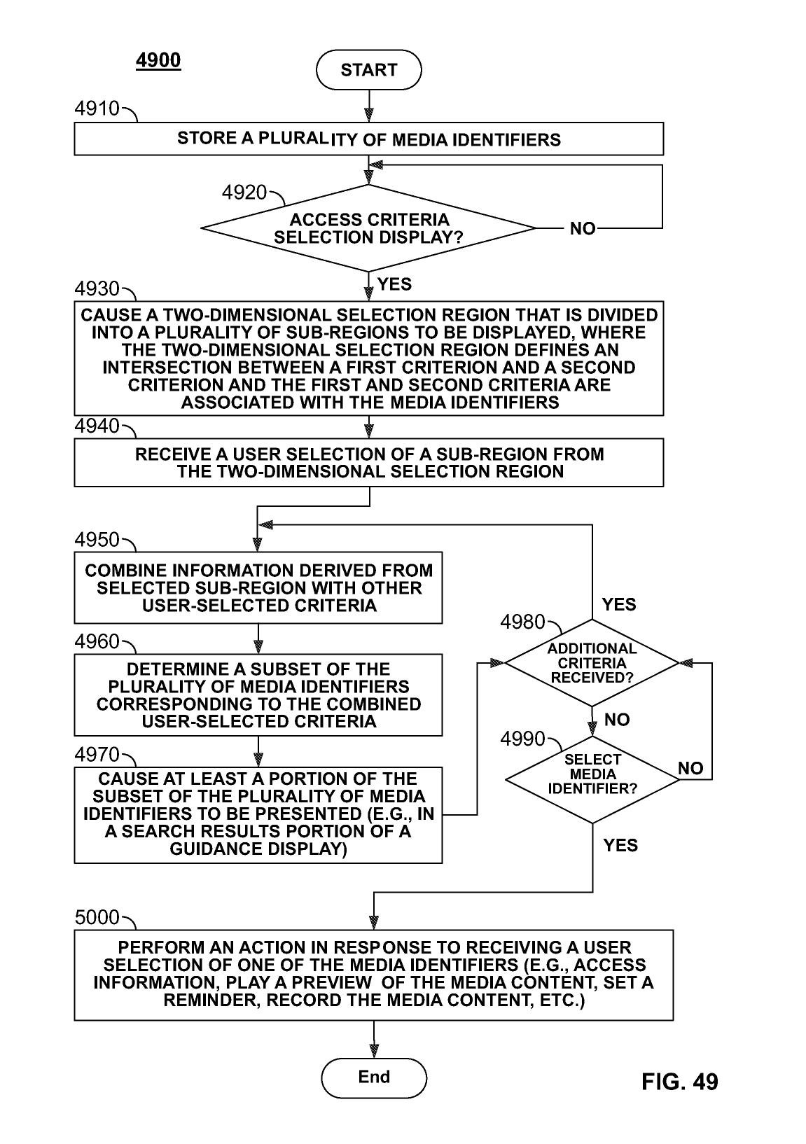

FIG. 49 illustrates a flow diagram 4900 for presenting an interactive media guidance application, where user-selected criteria is received and guidance for selecting media content is provided in accordance with some embodiments of the invention.

At step 4910, a plurality of media identifiers are stored. For example, control circuitry 304 may store media identifiers associated with media content. A media identifier may be, for example, a thumbnail of cover art shown in FIG. 13, a thumbnail of movie art, still images from the content, video clip previews, live video from the content, or any other suitable content that identifies the media content.

At step 4920, control circuitry 304 may determine whether an indication from the user has been received to access guidance display that allows the user to input criteria for searching and/or filtering media content. For example, control circuitry 304 may determine whether the user has navigated to a guidance display, such as the ones shown in FIGS. 8-14 and 19-27. In a more particular example, control circuitry 304 may receive an indication that the user has selected the findR button or a content selection tool option on a guidance display, such as the ones shown in FIGS. 6 and 7.

In response, control circuitry 304 may cause a two-dimensional selection region to be displayed at step 4930. As shown in FIGS. 8-14 and 19-27, the two-dimensional selection region is divided into a plurality of sub-regions for selection by the user. The two-dimensional selection region also defines an intersection between a first criterion and a second criterion. For example, as shown in FIG. 20, control circuitry 304 causes a two-dimensional selection region in a grid form to be presented to the user. The two-dimensional selection region shown in FIG. 20 defines the intersection between the positive-negative set of moods and the wild-chill set of moods. In particular, a sub-region indicates a particular selection between a “positive” mood and a “negative” mood (e.g., the music should be significantly more positive than negative), a particular selection between a “wild” mood and a “chill” mood (e.g., the music should be more chill than wild), and/or any combination or interaction between both (e.g., the music should be positive, but chill).

It should be noted that, although the embodiments described herein generally refer to a first mood and a second mood in the two-dimensional selection region, this is merely illustrative. Any suitable criterion may be placed in the two-dimensional selection region. In some embodiments, control circuitry 304 may allow the user to select and/or define criterion for placement on the two-dimensional selection region. For example, in some embodiments, control circuitry 304 may provide the user with a list populated with criterion information from database. The user may indicate criterion for placement on the two-dimensional selection region using the criteria list.

In some embodiments, control circuitry 304 may provide multiple two-dimensional selection regions for receiving user selections. For example, control circuitry 304 may provide a first two-dimensional selection region defining the intersection between a first set of moods and a second set of moods and a second two-dimensional selection region defining the intersection between a set of tones and a set of genres.

At step 4940, control circuitry 304 may receive a user selection of a sub-region from the plurality of sub-regions in the two-dimensional selection region. For example, using a user input device, the user may select one of the sub-region cells within the two-dimensional selection region. It should be noted that the two-dimensional selection region allows the user to indicate the extent of a mood or other criterion by selecting an area on or near an axis of the desired mood. For example, a user may set how wild or chill the music should be by selecting a location on the chill-wild axis.

In response to receiving a user selection of a sub-region from the two-dimensional selection region at step 4940, control circuitry 304 may derive information from the selected sub-region at step 4950. For example, control circuitry 304 may transmit a query to a database for media content using portions of information derived from user selection 2030—e.g., find media content with corresponding metadata that is at least 82% on the chill-wild mood scale (where chill is 0%, wild is 100%, and 50% is neither chill nor wild) and that is at least 46% on the negative-positive mood scale (where negative is 0%, positive is 100%, and 50% is neither negative nor positive).

It should be noted that, upon receiving a user selection (e.g., a user selection of a sub-region or any other user-selected criteria), control circuitry 304 may query the database to search and/or filter search results. Alternatively, at step 4950, control circuitry 304 may combine or aggregate the user selection from the sub-region and/or other user-selected criteria for submission to the database or other data source.

Any suitable mechanism for retrieving media content and/or their associated media identifiers to be presented in the guidance display may be used. For example, in some embodiments, control circuitry 304 may transmit a query to storage for media content and media identifiers with metadata matching user-selected criteria. In response to receiving media content and media identifiers from storage (e.g., in an XML structure as illustrated in FIG. 13), control circuitry 304 may determine which media content and media identifiers to present.

In response, control circuitry 304 may determine a subset of the plurality of media identifiers corresponding to the user-selected criteria at step 4960. For example, control circuitry 304 may determine which pieces of media content have metadata matching the user-selected criteria.

At step 4970, control circuitry 304 may cause at least a portion of the subset of media identifiers to be presented. For example, as shown in FIG. 19, in response to receiving user-selected criteria, control circuitry 304 may retrieve and present a subset of media identifiers in a search results portion 850 of a guidance display 800.

Control circuitry 304 may monitor to detect whether the user has provided additional criteria or modified criteria for searching and/or filtering media content at step 4980. In response to receiving additional criteria or modified criteria, control circuitry 304 may dynamically update the media content and their media identifiers presented in a search results region. For example, as the user moves through the two-dimensional selection region, control circuitry 304 may dynamically update the media identifiers presented in the search results region.

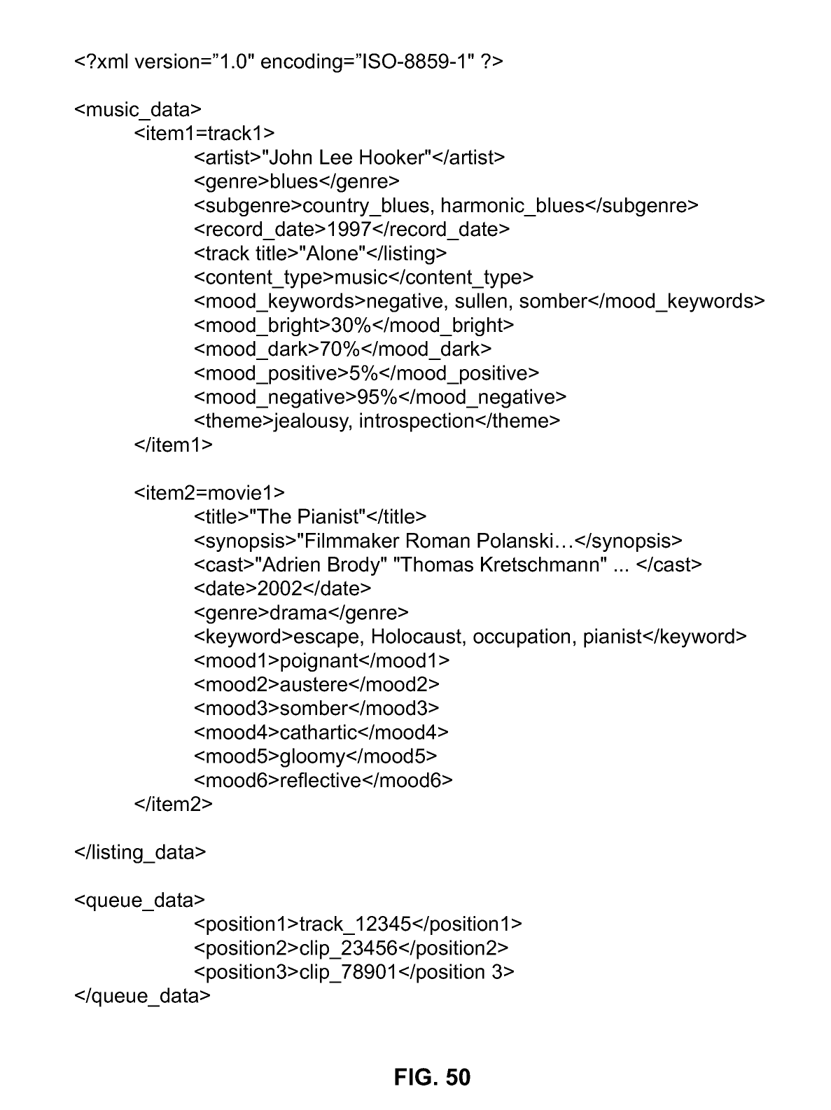

Any suitable mechanism for updating media identifiers may be used. For example, in some embodiments, control circuitry 304 may transmit a query to local storage to filter the currently displayed media identifiers with additional criteria. In response to receiving updated media identifiers from storage (e.g., in an XML structure as illustrated in FIG. 50), control circuitry 304 may present the updated media identifiers to the user.

At step 4990, control circuitry 304 may determine whether the user has indicated to access the media asset or media content corresponding to the selected media identifier. For example, the user may use a user input device to select the presented media identifier. In response, control circuitry 304 may perform a corresponding action at step 5000. For example, control circuitry 304 may access the corresponding media content. In another example, control circuitry 304 may provide the user with a preview of the media content (e.g., an audio sample, a trailer, a video clip, etc.). Additionally or alternatively to presenting the content corresponding to the selected media identifier, control circuitry 304 may provide the user with access to information, access to related media content, and/or provide the opportunity to set various settings, such as record the content, set a reminder to watch or listen to the content, etc. In some embodiments, control circuitry 304 may select the media identifier and instruct a second screen device (e.g., wireless user communications device 406) to playback the content, record the content, set a reminder to watch the content, etc.

Otherwise, if the user does not select one of the subset of media identifiers, control circuitry 304 may return back to step 4980 and continue to monitor to detect whether the user has provided additional criteria or modified criteria for searching and/or filtering media content.

It should be understood that the above steps of the flow diagram of FIG. 49 may be executed or performed in any order or sequence not limited to the order and sequence shown and described in the figure. Also, some of the above steps of the flow diagram of FIG. 49 may be executed or performed substantially simultaneously where appropriate or in parallel to reduce latency and processing times.

The above described embodiments of the present disclosure are presented for purposes of illustration and not of limitation, and the present disclosure is limited only by the claims which follow.

1. A method for providing guidance for selecting content, the method comprising:
storing a plurality of media identifiers;
causing a two-dimensional selection region to be presented to a user, wherein:
the two-dimensional selection region defines an intersection between a first criterion and a second criterion, the first criterion and the second criterion are associated with the plurality of media identifiers; and
the two-dimensional selection region is divided into a plurality of sub-regions;
receiving a user selection of a sub-region from the plurality of sub-regions within the two-dimensional selection region;
determining a subset of the plurality of media identifiers corresponding to the sub-region in response to receiving the user selection; and
causing at least a portion of the subset of the plurality of media identifiers to be presented to the user.

2. The method of claim 1, wherein each of the plurality of sub-regions defines a degree of the intersection between the first criterion and the second criterion, the method further comprising determining the subset of the plurality of media identifiers by determining the plurality of media identifiers that match the degree of the intersection between the first criterion and the second criterion.

3. The method of claim 1, further comprising:
receiving a plurality of criteria relating to the plurality of media identifiers from the user; and
filtering the plurality of media identifiers in response to receiving the plurality of criteria.

4. The method of claim 3, wherein the plurality of criteria includes one or more of: a mood, a genre, a subgenre, a rating, a time period, a demographic, and a theme.

5. The method of claim 3, further comprising selecting at least one of the first criterion and the second criterion based at least in part on the plurality of criteria received from the user.

6. The method of claim 1, further comprising selecting at least one of the first criterion and the second criterion based on profile information associated with the user.

7. The method of claim 1, further comprising selecting at least one of the first criterion and the second criterion based on usage history information associated with the user.

8. The method of claim 1, wherein each media identifier includes a media playback option, wherein selection of the media identifier causes information relating to a corresponding media asset to be presented to the user and wherein selection of the media playback option causes a media clip associated with the corresponding media asset to be presented to the user.

9. The method of claim 1, wherein at least one of the plurality of sub-regions within the two-dimensional selection region is shaded to indicate availability of the plurality of media identifiers.

10. The method of claim 1, further comprising:
retrieving relational information associated with each of the plurality of media identifiers that describes a relationship between media assets of a first media type and media assets of a second media type, wherein a media identifier selected by the user corresponds to a media asset of the first media type; and
causing a second media asset of the second media type to be presented to the user in response to receiving the relational information.

11. A system for providing guidance for selecting content, the system comprising:
a storage device;
processing circuitry configured to:
store a plurality of media identifiers in the storage device;
cause a two-dimensional selection region to be presented to a user, wherein:
the two-dimensional selection region defines an intersection between a first criterion and a second criterion, the first criterion and the second criterion are associated with the plurality of media identifiers; and
the two-dimensional selection region is divided into a plurality of sub-regions;
receive a user selection of a sub-region from the plurality of sub-regions within the two-dimensional selection region;
determine a subset of the plurality of media identifiers corresponding to the sub-region in response to receiving the user selection; and
cause at least a portion of the subset of the plurality of media identifiers to be presented to the user.

12. The system of claim 11, wherein each of the plurality of sub-regions defines a degree of the intersection between the first criterion and the second criterion and wherein the processing circuitry is further configured to determine the subset of the plurality of media identifiers by determining the plurality of media identifiers that match the degree of the intersection between the first criterion and the second criterion.

13. The system of claim 11, wherein the processing circuitry is further configured to:
receive a plurality of criteria relating to the plurality of media identifiers from the user; and
filter the plurality of media identifiers in response to receiving the plurality of criteria.

14. The system of claim 13, wherein the plurality of criteria includes one or more of: a mood, a genre, a subgenre, a rating, a time period, a demographic, and a theme.

15. The system of claim 13, wherein the processing circuitry is further configured to select at least one of the first criterion and the second criterion based at least in part on the plurality of criteria received from the user.

16. The system of claim 11, wherein the processing circuitry is further configured to select at least one of the first criterion and the second criterion based on profile information associated with the user.

17. The system of claim 11, wherein the processing circuitry is further configured to select at least one of the first criterion and the second criterion based on usage history information associated with the user.

18. The system of claim 11, wherein each media identifier includes a media playback option, wherein selection of the media identifier causes information relating to a corresponding media asset to be presented to the user and wherein selection of the media playback option causes a media clip associated with the corresponding media asset to be presented to the user.

19. The system of claim 11, wherein at least one of the plurality of sub-regions within the two-dimensional selection region is shaded to indicate availability of the plurality of media identifiers.

20. The system of claim 11, wherein the processing circuitry is further configured to:
retrieve, from the storage device, relational information associated with each of the plurality of media identifiers that describes a relationship between media assets of a first media type and media assets of a second media type, wherein a media identifier selected by the user corresponds to a media asset of the first media type; and
cause a second media asset of the second media type to be presented to the user in response to receiving the relational information.

21-30. (canceled)
